(19) United States
(12) Patent Application Publication
(10) Pub. No.: US 2019/0206009 A1
(43) Pub. Date: Jul. 4, 2019

(54) DYNAMICALLY FORECASTING AND DISPATCHING TRANSPORTATION VEHICLES TO TRAVELERS ON MASS-TRANSIT VEHICLES

(71) Applicant: Lyft, Inc., San Francisco, CA (US)

(72) Inventors: Kristina Gibson, San Francisco, CA (US); Christopher Levine, San Francisco, CA (US); Robert Joseph Marsan, San Francisco, CA (US); David Sifry, San Francisco, CA (US); Michael Li Wang, San Francisco, CA (US)

(21) Appl. No.: 15/859,264

(22) Filed: Dec. 29, 2017

(51) Int. Cl. G06Q 50/30; G06N 7/00; G06Q 50/14; G06Q 10/06

(52) U.S. Cl. CPC G06Q 50/30; G06N 7/005; G06Q 10/1097; G06Q 10/06315; G06Q 50/14

(57) ABSTRACT

This disclosure covers methods, non-transitory computer readable media, and systems that analyze sensory data from a client device to determine a user is traveling on a mass-transit vehicle and to dispatch a transportation vehicle for pickup of the user at a pickup location corresponding to a mass-transit station. To coordinate matching a user with a transportation vehicle, the methods, non-transitory computer readable media, and systems determine an estimated transit time of a user to one (or both) of the mass-transit station and the pickup location and select a transportation vehicle positioned to arrive at the pickup location by the estimated transit time.

### BACKGROUND

Service matching systems increasingly use web and mobile applications to manage on-demand requests for transportation. For example, on-demand service matching systems commonly receive requests from persons who use a mobile application to request transport from a work location to an entertainment venue, sporting venue, or other destination. On-demand service matching systems traditionally match requests with nearby providers of transportation services—as requests are received from requestor's devices.

But as a crowd of people arrive at certain venues using various modes of transportation, requests sometimes rapidly increase, placing significant burdens on computing systems implementing on-demand service matching systems. For example, when a crowd of users arrives at a particular venue, on-demand service matching systems often experience a sudden spike in digital transportation requests that exhaust (or inefficiently tax) available computing resources tasked with processing the transportation requests and (in a matter of milliseconds) generating and transmitting digital transportation assignments to corresponding transportation vehicles.

Not only do conventional online on-demand service matching systems inefficiently overload computing resources in response to mass arrivals at individual locations, but such systems also adversely impact requesters and drivers at high-volume transportation venues. Indeed, as a crowd of individuals arrives at a particular location, existing on-demand service matching systems can keep requesters and/or drivers waiting for excessive times in a transportation queue. At the same time, conventional on-demand service matching systems often send too many transportation vehicles too soon (or too few transportation vehicles too late) to match the incoming requests from persons at a venue. In addition to wasted time and resources, drivers idling in a transportation queue can cause significant adverse environmental and congestion impacts—a common problem at many transportation hubs. Furthermore, passengers waiting in a transportation queue can congest high-volume transportation centers and increase risk of injury to pedestrians. Accordingly, conventional on-demand service matching systems may create problems for both people requesting transportation vehicles at certain venues and for drivers providing transportation vehicles to requesters at such venues.

### SUMMARY

This disclosure describes one or more embodiments of methods, non-transitory computer readable media, and systems that solve the foregoing problems in addition to providing other benefits. While this summary refers to systems for simplicity, the summary also applies to certain disclosed methods and non-transitory computer readable media. To solve the foregoing and other problems, in one or more embodiments, the disclosed systems analyze sensory data from a client device to determine a user is traveling on a mass-transit vehicle and to dispatch a transportation vehicle to pick up the user at a pickup location corresponding to a mass-transit station. To coordinate matching a user with a transportation vehicle, in certain embodiments, the systems determine an estimated transit time of a user to one (or both) of the mass-transit station and the pickup location and select a transportation vehicle positioned to arrive at the pickup location by the estimated transit time.

In some embodiments, for instance, the systems determine that a user is traveling in a mass-transit vehicle based on sensory data from the user's client device. Upon making that determination, the systems can identify a station for the user and an estimated transit time of the user to the station. In one or more embodiments, the systems also provide the client device with a selectable option for requesting transport. Alternatively, in some embodiments, the systems determine a probability that the user will utilize a transportation vehicle departing from the station. When the systems receive an indication of a transportation request by the user (or determines a probability of the user utilizing a transportation vehicle), the systems can send a transportation-request notification to a transportation vehicle for pickup of the user at a pickup location corresponding to a station for the mass-transit vehicle.

The disclosed systems can avoid the deficiencies of conventional on-demand service matching systems. By analyzing sensory data to determine a user is traveling in a mass-transit vehicle and identifying a station for the user, the disclosed systems can estimate, in advance, when users arrive at mass-transit stations and pickup locations. Moreover, the systems can then prompt users on mass-transit vehicles to request a transportation vehicle while traveling (i.e., prior to arriving at a mass-transit station), reducing sudden spikes in requests and corresponding computing costs. Furthermore, by estimating transit time for users on mass-transit vehicles and transit time for transportation vehicles, the disclosed systems can more accurately dispatch transportation vehicles (e.g., dispatch the proper number of transportation vehicles for the number of users at the right times), reduce request queues at mass-transit stations, and efficiently match transportation vehicles with requesters. As suggested above, these improvements also reduce environmental waste, congestion, and pedestrian risk at mass-transit stations and pickup locations.

### BRIEF DESCRIPTION OF THE DRAWINGS

The detailed description refers to the drawings briefly described below.

FIG. 1 illustrates a block diagram of an environment for implementing a transportation matching system in accordance with one or more embodiments.

FIGS. 2A-2B illustrate sequence-flow diagrams of a transportation matching system determining a user is traveling on a mass-transit vehicle and dispatching a transportation vehicle for pickup of the user at a pickup location corresponding to a mass-transit station in accordance with one or more embodiments.

FIGS. 3A-3B illustrate conceptual diagrams of a transportation matching system determining a user is traveling on a mass-transit vehicle based on sensory data and sending a transportation-request notification to a transportation vehicle for pickup of the user at a pickup location corresponding to a mass-transit station in accordance with one or more embodiments.

FIGS. 4A-4C illustrate conceptual diagrams of a transportation matching system creating groups of users who are traveling on a mass-transit vehicle and sending transportation-request notifications to transportation vehicles for pickup of user groups at pickup locations corresponding to a mass-transit station in accordance with one or more embodiments.

FIG. 5 illustrates a conceptual diagram of determining estimated transit times for a user and estimated transit times for transportation vehicles in accordance with one or more embodiments.

FIGS. 6A-6B illustrate graphical user interfaces of a user client device presenting selectable options for requesting transport in accordance with one or more embodiments.

FIG. 7 illustrates a graphical user interface of a provider client device presenting a transportation-request notification in accordance with one or more embodiments.

FIG. 8 illustrates a flowchart of a series of acts for determining that a user is traveling on a mass-transit vehicle and sending a transportation-request notification in accordance with one or more embodiments.

FIG. 9 illustrates a flowchart of a series of acts for determining that a user is traveling on a mass-transit vehicle and sending a transportation-request notification in accordance with one or more embodiments.

FIG. 10 illustrates a block diagram of a computing device in accordance with one or more embodiments.

FIG. 11 illustrates an example environment for a transportation matching system in accordance with one or more embodiments.

### DETAILED DESCRIPTION

This disclosure describes one or more embodiments of a transportation matching system that analyzes sensory data from a client device to determine a user is traveling on a mass-transit vehicle and that dispatches a transportation vehicle for pickup of the user at a pickup location corresponding to a mass-transit station. To coordinate matching a user with a transportation vehicle, in certain embodiments, the transportation matching system determines an estimated transit time of a user to one (or both) of the mass-transit station and the pickup location and selects a transportation vehicle positioned to arrive at the pickup location by the estimated transit time.

In some embodiments, for instance, the transportation matching system determines that a user is traveling in a mass-transit vehicle based on sensory data from the user's client device. Upon making that determination, the transportation matching system can identify a station for the user and an estimated transit time of the user from a location of the mass-transit vehicle to the station. In one or more embodiments, the transportation matching system also provides the user's client device with a selectable option for requesting transport. When the transportation matching system receives an indication of a transportation request by the user (or determines a probability of the user utilizing a transportation vehicle), the transportation matching system can send a transportation-request notification to a transportation vehicle for pickup of the user at a pickup location corresponding to a station for the mass-transit vehicle.

As just mentioned, the transportation matching system can determine a transit time for a user on a mass-transit vehicle to a station (e.g., an airport or train station). When determining an estimated transit time for a user to a station, the transportation matching system can account for multiple factors. For example, in some embodiments, the transportation matching system relies on sensory data from a user's client device, such as sensory data from an accelerometer, altimeter, barometer, Global Positioning System (“GPS”) receiver, gyroscope, position sensor, and/or magnetometer. Additionally, in some embodiments, the transportation matching system uses sensory data from client devices associated with additional users within a mass-transit vehicle to determine a user's estimated transit time. In addition (or in the alternative) to sensory data, the transportation matching system uses scheduling information from a mass-transit system to determine a user's estimated transit time, such as an airline's flight status or a metropolitan transit system's estimated times of arrival.

To identify a station for a user's upcoming arrival, the transportation matching system may use various data sources. For example, in certain embodiments, the transportation matching system identifies a station based on a mass-transit vehicle's location and/or direction (e.g., by analyzing users' sensory data pushed or pulled from a user's client device and identifying an upcoming station). Additionally, or alternatively, the transportation matching system relies on a user's travel history to identify a station at which the user previously used or exited a mass-transit vehicle.

In addition to estimating transit times and identifying stations, in certain embodiments, the transportation matching system determines and compares various estimated transit times to select a transportation vehicle for transport. The transportation matching system also uses the transit times to determine when a transportation vehicle should arrive at a pickup location for a user traveling in a mass-transit vehicle. For instance, in some embodiments, the transportation matching system determines (i) an estimated transit time of the user from a location of the mass-transit vehicle to the station, (ii) an estimated transit time of the user from the mass-transit vehicle exit location within the station to a pickup location, and (iii) an estimated transit time of one or more provider transportation vehicles to the pickup location.

In some implementations, the transportation matching system further compares (i) an aggregate estimated transit time of the user from the location of the mass-transit vehicle to the pickup location with (ii) the estimated transit time for each of multiple transportation vehicles to the pickup location. Based on this comparison, the transportation matching system selects a transportation vehicle for pickup of the user from among the multiple transportation vehicles. For example, if the system determines that the user is 15 minutes from the pickup location and that there are providers 10, 15, and 20 minutes away from the pickup location, the system may select the vehicle that is 15 minutes to match with the request associated with the user. Further, in some embodiments, if the system determines that the average request originating from the transit station is matched within 2 minutes, the system may delay the match processing until 2 minutes before the determined arrival of the user at the pickup location and may match the user with the best match at the designated time prior to arrival of the user at the pickup location. Accordingly, in some embodiments, the system may determine that the user should be associated with a delayed or scheduled matching operation based on the availability and density of provider resources in the area of the transit station and based on the time of arrival of the user (e.g., the average available provider vehicle resources within the area may change based on the arrival time of the user).

As noted above, in some embodiments, the transportation matching system provides a user's client device with a selectable option for requesting transport. For example, the transportation matching system may provide a push notification to a user's client device suggesting transport from a transportation vehicle. When the user interacts with the push notification, the user's client device may provide a transportation-request option. Additionally, or alternatively, in certain embodiments, when a user opens a transportation user application (e.g., an application corresponding to the transportation matching system), the transportation matching system provides the user's client device with a transportation-request option.

In addition to arranging transportation services for individual users on mass-transit vehicles, the transportation matching system can also provide transportation services for user groups. For example, in some embodiments, the transportation matching system determines that multiple users are traveling in a mass-transit vehicle and dispatches one or more transportation vehicles to pick up user groups from among the multiple users. To facilitate matching transportation vehicles with users, the transportation matching system can create user groups based on one or more transit characteristics of the multiple users.

For example, the transportation matching system may create user groups based on (i) the location of users within a mass-transit vehicle, (ii) estimated transit times for users from a station to one or more pickup locations, or (iii) destinations indicated by transportation requests. Moreover, as circumstances or transit characteristics change, the transportation matching system may reorganize user groups. Upon creating or reorganizing user groups, the transportation matching system sends transportation-request notifications to transportation vehicles for pickup of user groups at one or more pickup locations.

Regardless of whether the transportation matching system arranges transportation services for an individual user or multiple users, the transportation matching system can also adjust pickup locations or suggest alternative stations. In particular, the transportation matching system can modify a pickup location and/or station based on a travel time (or route) to a user's ultimate destination, based on user-group reorganizations, and/or based on disruption events. For example, the transportation matching system may change a pickup location (or suggest an alternative station) in response to a publicly scheduled event near the station to avoid a crowd or in response to heavy vehicular traffic near the station.

The disclosed transportation matching system can avoid the deficiencies hindering conventional on-demand service matching systems. For example, by utilizing sensory data to identify users on mass-transit vehicles, the transportation matching system can accurately determine, in advance, transportation requests at stations and reduce spikes in computer-processing load. For instance, upon determining that a user is traveling in a mass-transit vehicle, the transportation matching system can provide a selectable option for requesting transport before the user arrives at a station. In this manner, the transportation matching system can spread digital transportation requests and reduce sudden spikes in computing load resulting from crowds arriving at a station.

In addition, the transportation matching system can more accurately dispatch transportation vehicles. By analyzing sensory data to determine that users are traveling in a mass-transit vehicle, the disclosed transportation matching system can estimate when, and how many, users will arrive at stations and pickup locations. Accordingly, the transportation matching system can more precisely dispatch the proper number of transportation vehicles for the users at an appropriate time. As such, embodiments allow the system to model request loads at transit stations and direct additional resources to the transit station prior to arrival by users at a pickup location to minimize delay and down time for users and transportation vehicle providers across the transportation matching system.

Furthermore, the transportation matching system can reduce transportation queues (for users and drivers) at stations. By more accurately assigning transportation vehicles, the transportation matching system can avoid assigning excess transportation vehicles to a station. Moreover, the transportation matching system can more accurately align user and transportation vehicles arrival times to avoid unnecessary waiting.

In addition, as noted above, the transportation matching system can more efficiently match transportation vehicles with requesters. While users are traveling to a station, the transportation matching system can identify and match a group of users to a particular transportation vehicle. Moreover, the transportation matching system can assign individual users and transportation vehicles to more efficient stations and/or pick-up locations. Accordingly, the transportation matching system can more efficiently align transportation vehicles with the needs of individual and/or group requesters.

Moreover, the transportation matching system can improve environmental impacts, crowding, and risk of accidents at mass-transit stations. By reducing transportation queues for transportation vehicles, the transportation matching system can reduce the amount of vehicle idling while waiting for requesters to arrive—a significant source of emissions at mass-transit stations. Moreover, by reducing transportation queues for users, the transportation matching system can reduce crowding at mass-transit centers, particularly in the dangerous regions adjacent to roads. Accordingly, the transportation matching system can also reduce risks to pedestrians navigating around or through pick up locations corresponding to mass-transit centers.

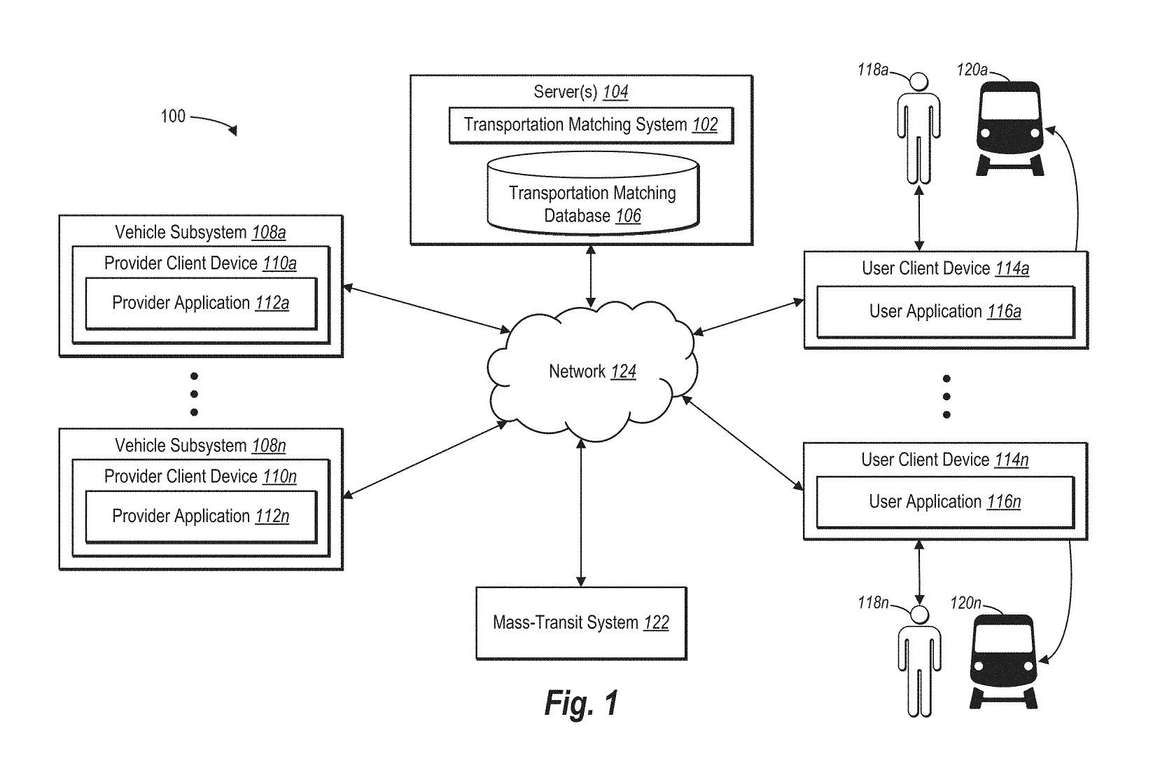

Turning now to the figures, FIG. 1 illustrates a schematic diagram of an environment 100 for implementing a transportation matching system 102 in accordance with one or more embodiments. This disclosure provides an overview of the transportation matching system 102 with reference to FIG. 1. After providing an overview, the disclosure describes components and processes of the transportation matching system 102 in further detail with reference to subsequent figures.

As shown in FIG. 1, the environment 100 includes server(s) 104, vehicle subsystems 108a-108n, user client devices 114a-114n, users 118a-118n (i.e., users traveling on mass-transit vehicles 120a-120n), a mass-transit system 122, and a network 124. Moreover, as illustrated, the server(s) 104 include a transportation matching system 102 and a transportation matching database 106. The transportation matching system 102 utilizes the network 124 to communicate between the server(s) 104 the vehicle subsystems 108a-108n, the user client devices 114a-114n, and the mass-transit system 122.

For instance, the transportation matching system 102, via the server(s) 104, communicates with the provider client devices 110a-110n and the user client devices 114a-114n via the network 124 to determine locations of the provider client devices 110a-110n and the user client devices 114a-114n, respectively. Per device settings, for instance, the transportation matching system 102 can utilize the server(s) 104 to receive sensory data from the provider client devices 110a-110n and/or the user client devices 114a-114n, respectively, to determine location coordinates for each device (e.g., longitudinal and latitudinal degrees). Similarly, the transportation matching system 102 can communicate with the mass-transit system 122 to determine a location or estimated times of arrival of the mass-transit vehicles 120a through 120n.

Although FIG. 1 illustrates the transportation matching system 102 as part of the server(s) 104, in one or more embodiments, the transportation matching system 102 is implemented, in whole or in part, by other computing devices within the environment 100. For example, in one or more embodiments, the transportation matching system 102 is implemented as part of the user client devices 114a-114n (e.g., as part of the user applications 116a-116n). Moreover, in some embodiments, the transportation matching system 102 is implemented as part of the vehicle subsystems 108a-108n (e.g., as part of the provider applications 112a-112n). Accordingly, the transportation matching system 102 can utilize the server(s) 140, the vehicle subsystems 108a-108n, the user client devices 114a-114n, and the mass-transit system 122 to arrange transportation vehicles for users traveling on mass-transit vehicles.

As used in this disclosure, the term “user” refers to a user of the transportation matching system 102. A user may request a ride or other form of transportation from the transportation matching system 102. As shown in FIG. 1, each of the users 118a-118n are respectively associated with the user client devices 114a-114n.

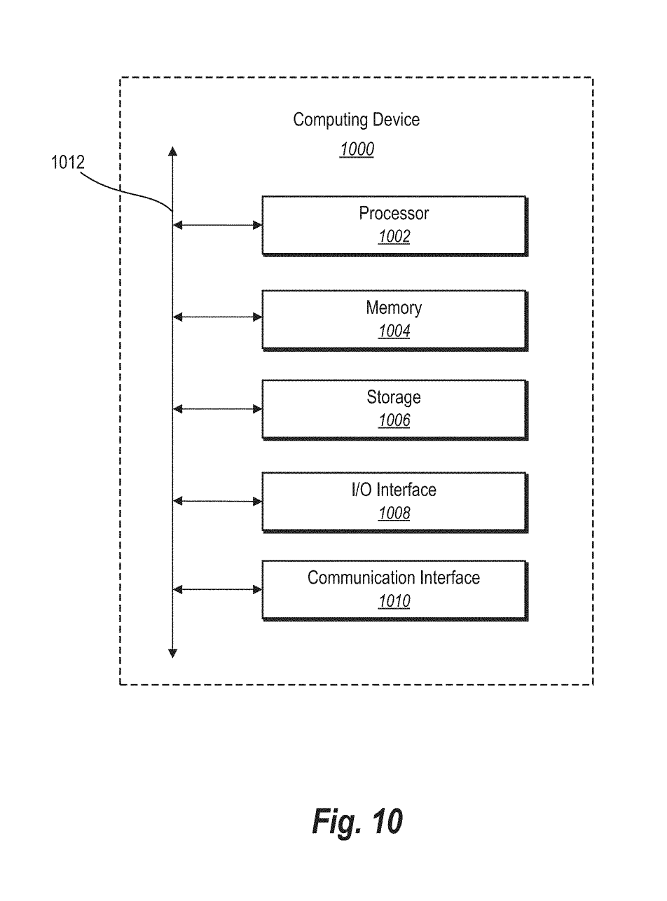

The term “user client device” refers to a computing device associated with a user. A user client device includes a mobile device, such as a laptop, smartphone, or tablet associated with a user. But the user client devices 114a-114n may also be any type of computing device as further explained below with reference to FIG. 10. Each of the user client devices 114a-114n respectively include user applications 116a-116n. In some embodiments, the user applications 116a-116n comprise web browsers, applets, or other software applications (e.g., native applications) available to the user client devices 114a-114n. As mentioned above, in some instances, the transportation matching system 102 is implemented on the user client devices 114a-114n via the user applications 116a-116n (e.g., the server(s) 104 provide data packets including instructions that, when executed by the user client devices 114a-114n, perform the functions or features of the transportation matching system 102).

A user may interact with a user application to request transportation services, receive a price estimate for the transportation service, and access other transportation-related services. For example, the user 118a may interact with the user client device 114a through graphical user interfaces of the user application 116a to input a mass-transit station, a more specific pickup location, or a destination for transportation. The transportation matching system 102, via the server(s) 104, in turn provide the user client device 114a with a price estimate for the transportation and an estimated time of arrival of a provider (or transportation vehicle) through the user application 116a. Having received the price estimate, the user 118a may then select (and the user client device 114a detect) a selection of a transportation-request option to request transportation services from the transportation matching system 102.

As further shown in FIG. 1, the user client devices 114a-114n are located respectively within the mass-transit vehicles 120a-120n. As FIG. 1 suggests, because the user client devices 114a-114n are within the mass-transit vehicles 120a-120n, the users 118a-118n are also within the mass-transit vehicles 120a-120n. As used in this disclosure, the term “mass-transit vehicle” refers to a vehicle that transports multiple people. In particular, the term “mass-transit vehicle” includes a vehicle for providing transportation to multiple members of the public at large (e.g., using a public transportation vehicle) or to multiple private travelers (e.g., using a private transportation vehicle). For example, a mass-transit vehicle may include, but is not limited to, an airplane, a bus, a subway, or a train. In some embodiments, the mass-transit system 122 coordinates mass-transit vehicles to transport people from one location to another according to a publicly available schedule. In certain embodiments, however, a mass-transit vehicle is a private vehicle that transports a group of people on a per-trip basis, such as a privately chartered airplane or bus or a private train.

In some embodiments, a user client device sends sensory data to the transportation matching system 102 while a user travels in a mass-transit vehicle. As used in this disclosure, the term “sensory data” refers to data from a sensor of a client device. In particular, “sensory data” includes digital information reflecting measurements of a location, elevation, pressure, movement, speed, orientation, and/or position sensor within a client device. For example, sensory data may include, but is not limited to, data from an accelerometer, altimeter, barometer, GPS receiver, gyroscope, and/or magnetometer. In certain embodiments, user client devices send sensory data to the transportation matching system 102 only after a user opts in to share such sensory data, such as by selecting an option to share sensory data with the transportation matching system 102. In some embodiments, the user client device 114a sends the transportation matching system 102 location data from a GPS receiver. Based on the location data, the transportation matching system 102 may determine that the user client device 114a (and associated user 118a) are traveling within a train (e.g., by determining that coordinates from the location data corresponding to a train route). Alternatively, based on the location data, the transportation matching system 102 may determine that the user client device 114a (and associated user 118a) are traveling within a bus (e.g., by determining that coordinates from the location data corresponding to a bus route).

In another embodiment, the user client device 114a sends atmospheric data from a barometer of the user client device 114a indicating an atmospheric pressure. Based on location data, accelerometer data, and atmospheric data from sensors of the user client device 114a, the transportation matching system 102 may determine that the user client device 114a (and associated user 118a) are traveling in an airplane or other mass-transit vehicle.

In addition to determining that a user is traveling within a mass-transit vehicle, the transportation matching system 102 may also identify a station for the mass-transit vehicle. For instance, in certain embodiments, the transportation matching system 102 determines that the user 118a previously used or exited a mass-transit vehicle at a particular station and that a mass-transit vehicle carrying the user 118a is traveling toward the station. As used in this disclosure, the term “station” refers to a location for loading or unloading passengers of a mass-transit vehicle. In particular, the term “station” includes a depot, port, stop, or terminus of a mass-transit vehicle. Accordingly, a station includes, but is not limited to, an airport, a bus station, a train station, or a seaport. This disclosure uses the terms “mass-transit station” and “station” interchangeably.

In addition to identifying a station for a mass-transit vehicle or user, in some embodiments, the transportation matching system 102 receives price queries and arrival queries from the user client devices 114a-114n. For example, in some embodiments, when a user opens or initiates a transportation user application, the corresponding user client device sends a query for a price estimate and/or a query for an estimated time of arrival. A user may subsequently enter a pickup location and destination for transportation (and optionally selects a transportation type) by interacting with graphical user interfaces of a user application.

In some embodiments, upon detecting a station or pickup location and destination for a potential transportation service, the user's associated user client device automatically sends a query for a price estimate (or a “price query”) and/or a query for an estimated time of arrival (or “arrival query”) to the transportation matching system 102. In some such embodiments, a user client device sends a single query for both price and arrival to the transportation matching system 102.

As suggested by FIG. 1, the transportation matching system 102 sends transportation requests from users 118a-118n to provider client devices 110a-110n within a vehicle subsystem. As used in this disclosure, the term “transportation request” refers to a request for a transportation vehicle to transport at least one user. In particular, the term “transportation request” includes a request by a user or by the transportation matching system 102 for a transportation vehicle to transport a user or a group of users. In some embodiments, a transportation request indicates a pickup location or, alternatively, a mass-transit station as a reference point for a pickup location. Additionally, in certain embodiments, a transportation request indicates a destination where the transportation vehicle is to transport the user.

In response to a user selecting a transportation-request option, the transportation matching system 102 generally sends transportation requests to a provider client device in the form of a transportation-request notification. In some embodiments, the transportation matching system 102 anticipates a user selecting a transportation-request option and sends a transportation-request notification to a provider client device without receiving an indication of a selection of a transportation-request option by the user.

As used in this disclosure, the term “transportation-request notification” refers to a notice that a user (or the transportation matching system 102) has requested transport of the user in a transportation vehicle. For example, in some embodiments, the transportation-request notification indicates an identity of the requesting user and a pickup location. The transportation-request notification optionally indicates a destination indicated by a corresponding transportation request. Further, in some embodiments, the transportation-request may include an arrival time, a current location of the user, a type of vehicle or mode of transportation requested, and/or any other suitable information that may be used to match a transportation vehicle with the user or to otherwise provide transportation to the user.

The transportation matching system 102 communicates with vehicle subsystems 108a-108n to relay transportation-request notifications. As used in this disclosure, the term “vehicle subsystem” refers to a system comprising a transportation vehicle, provider client device, and other components. Relatedly, the term “transportation vehicle” refers to a vehicle that transports one or more persons for a transportation matching system, such as an airplane, automobile, motorcycle, or other vehicle. This disclosure primarily describes transportation vehicles as automobiles, such as cars, mopeds, shuttles, or sport utility vehicles, but a vehicle subsystem may use other transportation vehicles, such as a boat.

Although this disclosure often describes a transportation vehicle as performing certain functions, the transportation vehicle includes an associated provider client device that often performs a corresponding function. For example, when the transportation matching system 102 sends a transportation-request notification to a transportation vehicle within the vehicle subsystem 108a—or queries location information from a transportation vehicle within the vehicle subsystem 108a—the transportation matching system 102 sends the transportation-request notification or location query to the provider client device 110a.

As used in this disclosure, the term “provider” refers to a driver or other person who operates a transportation vehicle and/or who interacts with a provider client device. For instance, a provider includes a person who drives a transportation vehicle along various routes to pick up and drop off users. In certain embodiments, the vehicle subsystems 108a-108n include a provider. However, in other embodiments, some or all of the vehicle subsystems 108a-108n do not include a provider, but include autonomous transportation vehicles—that is, a self-driving vehicle that includes computer components and accompanying sensors for driving without manual-provider input from a human operator.

As noted above, the vehicle subsystems 108a-108n respectively include provider client devices 110a-110n. The term “provider client device” refers to a computing device associated with a provider. The provider client devices 110a-110n may be separate or integral to transportation vehicles. For example, the provider client device 110a may refer to a separate mobile device, such as a laptop, smartphone, or tablet associated with the vehicle subsystem 108a. But the provider client devices 110a-110n may be any type of computing device as further explained below with reference to FIG. 10. Additionally, or alternatively, the provider client device 110a may be a subcomponent of a vehicle computing system. Regardless of its form, the provider client devices 110a-110n may include various sensors, such as a GPS locator, an inertial measurement unit, an accelerometer, a gyroscope, a magnetometer, and/or other sensors that the transportation matching system 102 can access to obtain information, such as location information.

As further shown in FIG. 1, the provider client devices 110a-110n respectively include provider applications 112a-112n. In some embodiments, the provider applications 112a-112n comprise web browsers, applets, or other software applications (e.g., native applications) available to the provider client devices 110a-110n. In some instances, the transportation matching system 102 provides data packets including instructions that, when executed by the provider client devices 110a-110n, create or otherwise integrate provider applications 112a-112n within an application or webpage.

In some embodiments, the transportation matching system 102 communicates with the provider client devices 110a-110n through the provider applications 112a-112n. The provider applications 112a-112n optionally include computer-executable instructions that, when executed by the provider client devices 110a-110n, cause the provider client devices 110a-110n to perform certain functions. For instance, the provider applications 112a-112n can cause the provider client devices 110a-110n to communicate with the transportation matching system 102 to receive a transportation-request notification, communicate with the user, navigate to a pickup location to pick up a user, monitor the status of transport, and collect fares for the transportation.

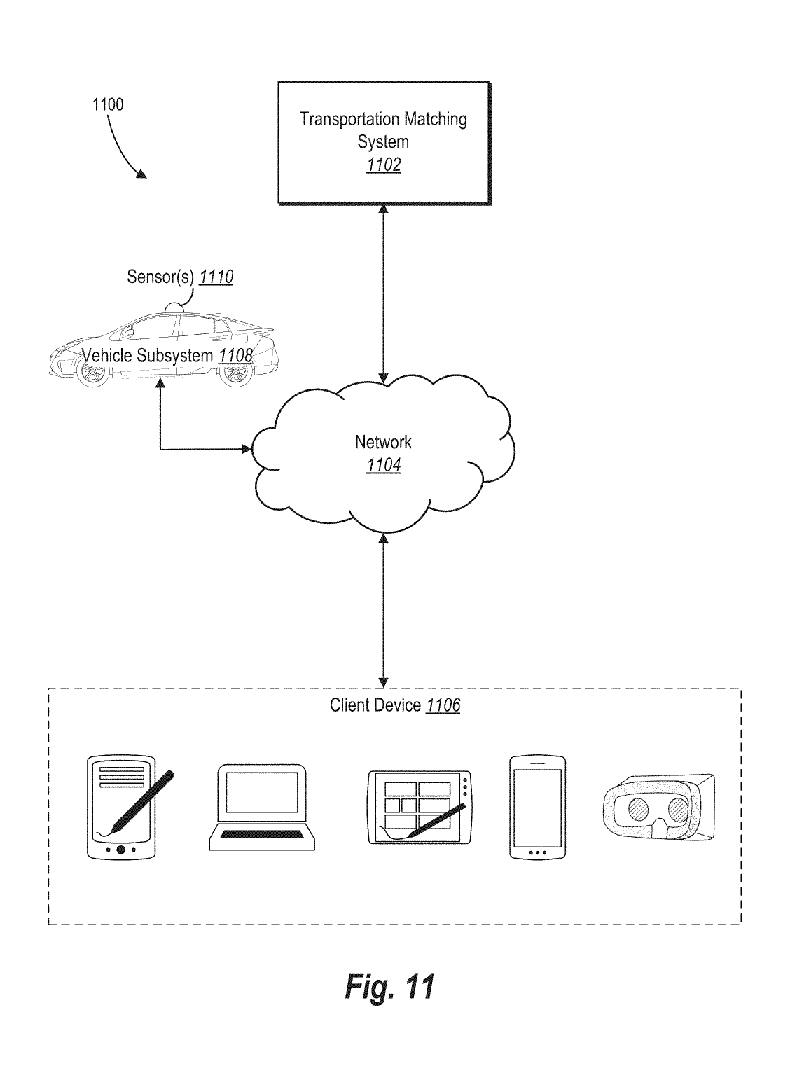

As described further below with reference to FIG. 11, in certain embodiments, the transportation matching system 102 connects transportation requests with transportation vehicles. By connecting requests with transportation vehicles, the transportation matching system 102 manages the distribution and allocation of vehicle subsystems 108a-108n and other user resources, such as GPS location and availability indicators. To facilitate connecting requests with transportation vehicles, the transportation matching system 102 communicates with the provider client devices 110a-110a (through the provider applications 112a-112n) and with the user client devices 114a-114n (through the user applications 116a-116n).

In addition to connecting transportation requests with transportation vehicles, the transportation matching system 102 optionally stores data corresponding to each transportation request on a transportation matching database 106 accessed by the server(s) 104. Accordingly, the server(s) 104 may generate, store, receive, and transmit various types of data, including, but not limited to, location information, price estimates, estimated times of arrival, pickup locations, dropoff locations, mass-transit vehicles and stations used by a user, and other data stored in the transportation matching database 106. In some such embodiments, the transportation matching system 102 organizes and stores such data in the transportation matching database 106 by user, geographic district, or time period.

As further indicated in FIG. 1, the server(s) 104 may comprise a content server. The server(s) 104 can also comprise a communication server or a web-hosting server. Additional details regarding the server(s) 104 will be discussed below with respect to FIG. 10. Although not illustrated in FIG. 1, in some embodiments, the environment 100 may have a different arrangement of components and/or may have a different number or set of components altogether. For example, in some embodiments, the transportation matching system 102 and the provider client devices 110a-110n can communicate directly, bypassing the network 124.

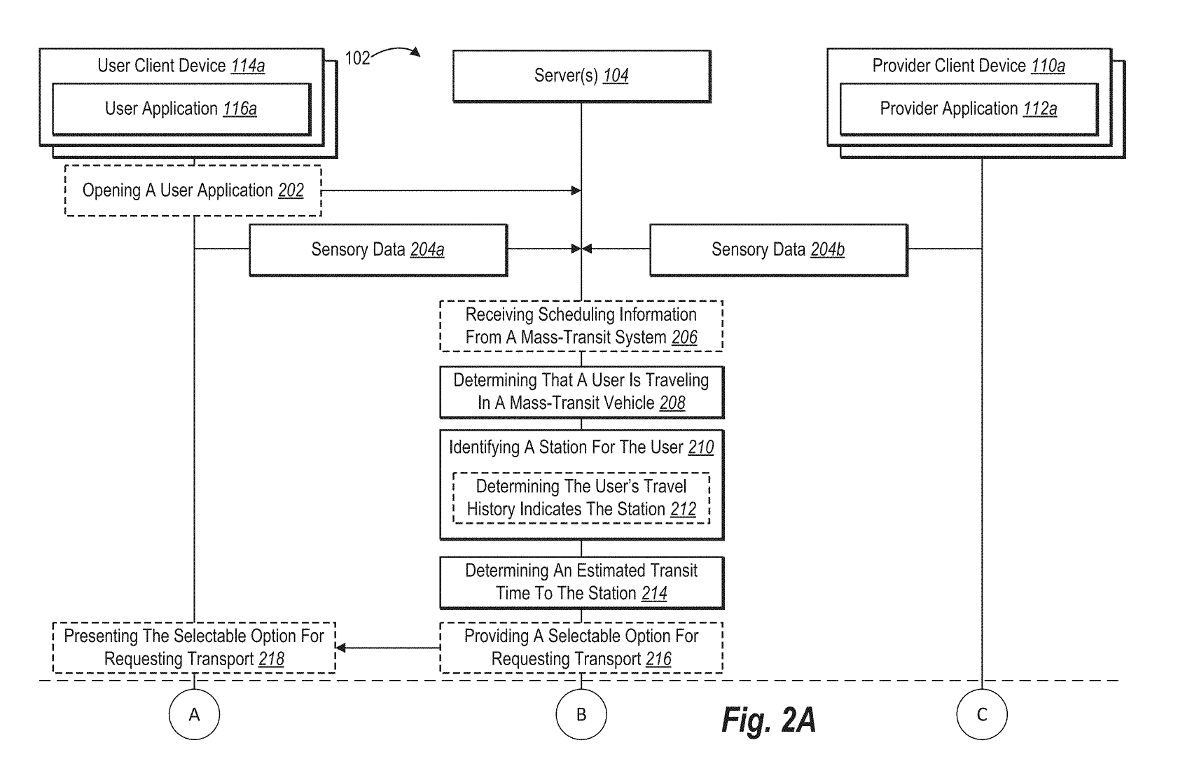

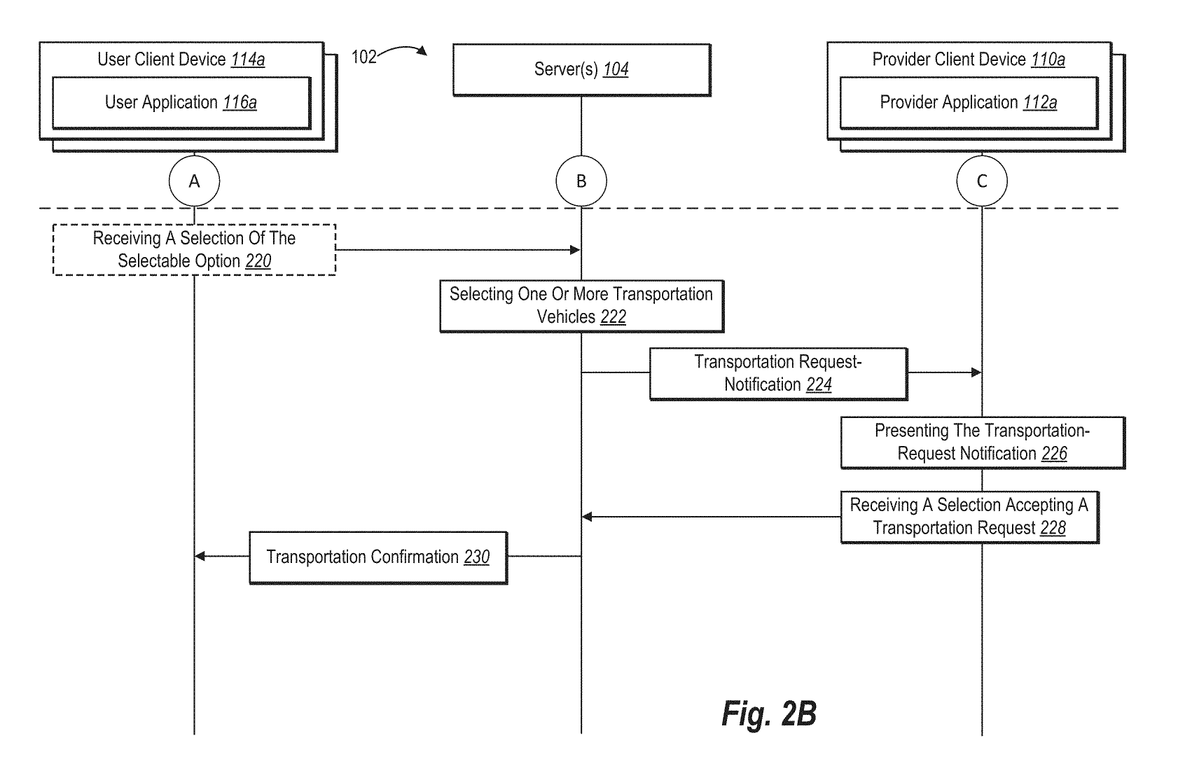

Turning now to FIGS. 2A-2B, these figures illustrate sequence-flow diagrams of a sequence of acts 202-230 that the transportation matching system 102 may perform to determine a user is traveling in a mass-transit vehicle, determine a transit time of the user to a mass-transit station, and send a transportation-request notification to a provider client device. In particular, as shown, the transportation matching system 102 utilizes communications between the server(s) 104, the user client device 114a (e.g., via the user application 116a), and the provider client device 110a (e.g., via the provider application 112a) to perform the acts 202-230. Rather than repeatedly describing the transportation matching system 102 causing the server(s) 104, the user client device 114a, or the provider client device 110a to perform certain acts, this disclosure sometimes describes the server(s) 104, the user client device 114a, or the provider client device 110a as performing the acts 202-230.

Turning back now to FIG. 2A, as shown, the user client device 114a performs the act 202 of opening a user application. In particular, the user client device 114a opens or initiates the user application 116a. As indicated by the arrow associated with the act 202, the user client device 114a also sends an indication to the server(s) 104 that the user client device 114a opens or initiates the user application 116a. When the user client device 114a opens the user application 116a, the transportation matching system 102 utilizes the server(s) 104 to pull the sensory data (or utilizes the user client device 114a to push the sensory data to the server(s) 104).

Accordingly, as further shown in FIG. 2A, the user client device 114a performs the act 204a of sending sensory data to the server(s) 104. Similarly, the provider client device 110a performs the act 204b of sending sensory data to the server(s) 104. The server(s) 104 in turn receive sensory data from both the user client device 114a and the provider client device 110a. As indicated above, in some embodiments, the user client device 114a sends the sensory data in response to opening the user application 116a. In certain embodiments, the user 118a selects user settings that permit the user client device 114a to send sensory data to the server(s) 104 without opening or initiating the user application 116a.

The sensory data may come in various forms. In one embodiment, for example, the user client device 114a sends atmospheric data from a barometer, gyroscopic data from a gyroscope, location data from a GPS receiver, and accelerometer data from an accelerometer to the server(s) 104. The accelerometer data and gyroscopic data indicate to the transportation matching system 102 a speed, direction, and/or rotation of the user client device 114a. Moreover, the location data from the GPS receiver indicates the location of the user client device 114a, such as by longitudinal and latitudinal degrees. The atmospheric data from the barometer indicates the atmospheric pressure surrounding the user client device 114a. The user client device 114a may further send altitude data to the server(s) 104 indicating the altitude of the user client device 114a. Among other things, the transportation matching system 102 uses this sensory data to determine whether the user client device 114a is within a mass-transit vehicle.

Similarly, in some embodiments, the provider client device 110a sends gyroscopic data from a gyroscope, location data from a GPS receiver, and accelerometer data from an accelerometer to the server(s) 104. The accelerometer data and gyroscopic data indicate to the transportation matching system 102 a speed, direction, and rotation of the provider client device 110a. Moreover, the location data from the GPS receiver indicates the location of the provider client device 110a. The provider client device 110a may further send sensory data from a magnetometer. As discussed below, the transportation matching system 102 uses this sensory data to determine the location and direction of a transportation vehicle.

As further shown in FIG. 2A, the transportation matching system 102, via the server(s) 104, performs the act 206 of receiving scheduling information from a mass-transit system. For instance, the scheduling information may be a static schedule or updated scheduling information (e.g., real-time updates). For example, in response to a data pull, the mass-transit system 122 may send an airline's flight tracker information indicating an airplane's departure time, current location, and estimated time of arrival. Additionally, or alternatively, the mass-transit system 122 may send a schedule of flight departure and arrival times. As another example, the mass-transit system 122 may send tracking information for particular buses, trains, or other mass-transit vehicles, including their current locations and estimated times of arrival at a given station. Similarly, the mass-transit system 122 may also send a schedule of departure and arrival times for particular trains or buses at specific stations.

The transportation matching system 102 uses one or both of the sensory data and scheduling information to determine whether a user is traveling in a mass-transit vehicle. For instance, as further shown in FIG. 2A, the transportation matching system 102, via the server(s) 104, performs the act 208 of determining that a user is traveling in a mass-transit vehicle. In certain embodiments, the transportation matching system 102 relies on sensory data from the user client device 114a to determine that the user 118a is traveling in a mass-transit vehicle. For example, the transportation matching system 102 may determine a location, speed, and/or direction of the user client device 114a based on location data, accelerometer data, and/or gyroscopic data from the user client device 114a. Based on repeated cycles of this sensory data from the user client device 114a, for instance, the transportation matching system 102 determines that the user client device 114a (and associated user 118a) is traveling within a train or other mass-transit vehicle.

For example, in certain embodiments, the user client device 114a repeatedly sends location coordinates to the transportation matching system 102. The transportation matching system 102 subsequently determines (i) the location coordinates correspond to a train route within a digital map and (ii) the average speed at which the user client device 114a is traveling (as indicated by the time traveled between location coordinates) is consistent with a speed of a train along the train route.

As further shown in FIG. 2A, in addition to determining that a user is traveling in a mass-transit vehicle, the transportation matching system 102, via the server(s) 104, performs the act 210 of identifying a station for the user. For example, the transportation matching system 102 may determine a station based on sensory data received from the user client device 114a. In some cases, location data and accelerometer data may indicate a station for the user 118a. For example, the location and direction of travel of the user client device 114a may indicate an upcoming bus or train station or an airport located at or near location coordinates from the user client device 114a.

As suggested above, in some cases, the transportation matching system 102 uses a user's travel history to determine a station. Accordingly, as shown in FIG. 2A, the transportation matching system 102, via the server(s) 104, performs the act 212 of determining the user's travel history indicates a station. As discussed above, server(s) 104 can store a user's travel history within the transportation matching database 106. A user's travel history may include, for example, stations from which (or to which) a transportation vehicle picked up (or dropped off) the user 118a. In some embodiments, the transportation matching system 102 analyzes a user's travel history to identify a station at which the user previously used a mass-transit vehicle, such as a previous train station where the user 118a boarded or exited a train or a previous airport where the user 118a boarded or exited an airplane.

As further shown in FIG. 2A, after identifying a station, the transportation matching system 102, via the server(s) 104, performs the act 214 of determining an estimated transit time to the station. For instance, the transportation matching system 102 may determine the estimated transit time of the user 118a from a location of the mass-transit vehicle to the identified station based on sensory data. In some such embodiments, the transportation matching system 102 determines an estimated transit time to the station from a location, direction, and speed of the mass-transit vehicle indicated by the sensory data of the user client device 114a. In some embodiments, the transportation matching system 102 likewise determines an estimated transit time for each user within a mass-transit vehicle to the station based on each set of sensory data from user client devices determined to be within the mass-transit vehicle. Additionally, or alternatively, the transportation matching system 102 determines an estimated transit time to the station based on scheduling information from the mass-transit system 122, or historical travel information from one or more users (e.g., average time taken for a plurality of users to travel on a train to the station at a particular time of day).

The transportation matching system 102 may use some or all of the data sources just described to determine the estimated transit time of a user from a location of the mass-transit vehicle to the station. For instance, in some embodiments, the transportation matching system 102 determines the estimated transit time to the station based on an average of estimated transit times from each the user client devices within the mass-transit vehicle and the scheduling information from the mass-transit system 122. In some such embodiments, the transportation matching system 102 assigns weights to each individual estimated transit time as part of determining a weighted average of estimated transit times to the station.

As further shown in FIG. 2A, after determining an estimated transit time, the transportation matching system 102, via the server(s) 104, performs the act 216 of providing a selectable option for requesting transport. As indicated by the arrow associated with the act 216, the transportation matching system 102, via the server(s) 104, provides the selectable option to the user client device 114a. The user client device 114a then performs the act 218 of presenting the selectable option for requesting transport.

In some embodiments, the selectable option includes one or both of a push notification suggesting transport of a user from the transportation matching system 102 and a transportation-request option. In either instance, the selectable option can indicate or suggest a station as a reference point for a pickup location.

As shown in FIG. 2B, after presenting the selectable option, the user client device 114a also performs the act 220 of receiving a selection of the selectable option. As indicated by the arrow associated with the act 220, the user client device 114a sends an indication of the selection to the server(s) 104. This indication represents a transportation request by the user 118a for a transportation vehicle. As noted above, the transportation request optionally indicates the station as a reference point for a pickup location and (sometimes) a destination for the transportation vehicle.

As noted above, the transportation matching system 102 can send a transportation-request notification to a provider client device without receiving an indication of a selection of a transportation-request option by the user. In some such embodiments, the transportation matching system 102 determines a probability that the user 118a will utilize a transportation vehicle departing from a station. Based on such a determination, the transportation matching system 102 sends a transportation-request notification to a provider client device. For example, in some embodiments, the transportation matching system 102 analyzes one or more of (i) travel history, (ii) sensory data, or (iii) scheduling information from a mass-transit system to determine a probability that the user 118a utilizes a transportation vehicle departing from a station.

Consistent with the disclosure above, the transportation matching system 102 analyzes a travel history of the user 118a to identify a station or pickup location from which the user 118a previously used a transportation vehicle. Additionally, the transportation matching system 102 can analyze a travel history of the user 118a to identify times of day, days of the week, and/or dates of the year to identify when the user 118a previously used a transportation vehicle departing from a station or pickup location within a threshold distance of the station. For example, the travel history of the user 118a may indicate that on Mondays at or around 8:35 a.m.—within a certain percentage of time—the user 118a utilizes a transportation vehicle from the transportation matching system 102 departing from a pickup location near a station. This may by itself (or combined with sensory data or scheduling information) indicate a probability that the user 118a will utilize a transportation vehicle departing from a station

Additionally, or alternatively, in some embodiments, the transportation matching system 102 analyzes sensory data received from the user client device 114a to determine a location, speed, and/or direction of the user client device 114a. Consistent with the disclosure above, the transportation matching system 102 may analyze sensory data from the user client device 114a to determine that a mass-transit vehicle carrying the user client device 114a is traveling toward a station. In some embodiments, the sensory data indicates a location and direction that correlates with the travel history. For example, the sensory data may indicate on a Monday on or around 8:00 a.m. that the user 118a is currently traveling on a mass-transit vehicle toward a station from which the user 118a uses a transportation vehicle a certain percentage of the time.

In addition to one or both of travel history and sensory data, the transportation matching system 102 can analyze scheduling information from a mass-transit system to determine probability of using a transportation vehicle. For example, the transportation matching system 102 may identify a scheduled arrival of a mass-transit vehicle from an updated schedule or static schedule that corresponds to the travel history of the user 118a or sensory data of the user client device 114a. The scheduling information can indicate, for instance, a train arriving at a station—or a plane arriving at an airport gate—that corresponds to a train or plane indicated by the travel history of the user 118a or sensory data of the user client device 114a.

To determine a probability of using a transportation vehicle, in some embodiments, the transportation matching system 102 generates a probability score representing one or more of the travel history, sensory data, or scheduling information. For instance, the transportation matching system 102 assigns a percentage and a weight to one or more factors based on a (i) travel history, (ii) sensory data, and (iii) scheduling information. In some such embodiments, the probability score represents the weighted sum of the percentages for each factor.

As shown in FIG. 2B, in addition to receiving an indication of the selection, the transportation matching system 102, via the server(s) 104, performs the act 222 of selecting one or more transportation vehicles. To select a transportation vehicle, in some embodiments, the transportation matching system 102 determines an estimated transit time for each of multiple transportation vehicles around, near, or traveling toward or near the station. Accordingly, the multiple transportation vehicles may include transportation vehicles currently transporting other users but that are nevertheless available to pick up the user 118a from the station. The transportation matching system 102 may determine, for instance, an estimated transit time of each transportation vehicle within a geographic district or a larger geographic neighborhood of a station. The transportation matching system 102 then compares (i) an aggregate estimated transit time of the user 118a from a location of the mass-transit vehicle to a pickup location corresponding to the station with (ii) the estimated transit time for each of the multiple transportation vehicles to the pickup location. Based on this comparison, the transportation matching system 102 selects one or more transportation vehicles to receive a transportation-request notification.

For example, the transportation matching system 102 can select the transportation vehicle with the transit time closest to the transit time of the user (e.g., to minimize the waiting time for the transportation vehicle and/or the user). Moreover, the transportation matching system 102 can also select the transportation vehicle with the shortest estimated transit time to a pickup location after the estimated transit time for the user 118a falls below a threshold. The transportation matching system 102 may further consider additional factors when selecting transportation vehicles, such as provider rating or vehicle type. In the example shown in FIG. 2B, the transportation matching system 102 selects the transportation vehicle corresponding to the provider client device 110a.

Additionally, or alternatively, in certain embodiments, the transportation matching system 102 selects one or more transportation vehicles to receive a transportation-request notification as (or after) the user 118a arrives at the station. For example, after determining the user 118a is traveling on a mass-transit vehicle to a station, the transportation matching system 102 determines a number of transportation vehicles available to transport users from the station. Upon determining that the number of available transportation vehicles falls below (or satisfies) a threshold number of available transportation vehicles, in some cases, the transportation matching system 102 postpones selecting a transportation vehicle for the user 118a. By postponing the selection, the transportation matching system 102 avoids depleting transportation vehicles available to transport users at the station. When the user client device 114a sends sensory data indicating that the mass-transit vehicle arrives at the station—or that the mass-transit vehicle is within a threshold time or distance from the station—the transportation matching system 102 selects one or more transportation vehicles to receive a transportation-request notification based on availability (e.g., by selecting a transportation vehicle closest to a pickup location for the user 118a or selecting a transportation vehicle dispatched to a location near a destination for the user 118a).

After selecting one or more transportation vehicles, the transportation matching system 102, via the server(s) 104, performs the act 224 of sending a transportation-request notification to the provider client device 110a. In some embodiments, a transportation-request notification includes a selectable option for a provider to accept or reject the transportation request. As shown in FIG. 2B, the provider client device 110a performs the act 226 of presenting the transportation-request notification and the act 228 of receiving a selection accepting a transportation request. In this example, when a provider interacts with a selectable option within the transportation-request notification, the provider client device 110a detects a selection accepting the transportation request from the user 118a. As indicated by the arrow associated with the act 228, the provider client device 110a sends an indication of the selection accepting the transportation request to the server(s) 104.

As further shown in FIG. 2B, after receiving the indication of the selection, the transportation matching system 102, via the server(s) 104, performs the act 230 of sending a transportation confirmation to the user client device 114a. In some embodiments, the transportation confirmation indicates an identity of the provider, an estimated time of arrival of a transportation vehicle, and the pickup location. As time passes, the transportation matching system 102 optionally updates the estimated time of arrival for the transportation vehicle.

The acts 202-230 described in relation to FIGS. 2A-2B are intended to be illustrative of an exemplary sequence of acts in accordance with the present disclosure, and are not intended to limit potential embodiments. Alternative embodiments can include additional, fewer, or different acts than those articulated in FIG. 2A-2B. For instance, as indicated by the dashed lines of FIGS. 2A-2B, in some embodiments, the transportation matching system 102 omits one or more of the acts 202, 206, 208, 212, 216, 218, or 220 as optional.

Additionally, the acts described herein may be performed in a different order, may be repeated or performed in parallel with one another, or may be performed in parallel with different instances of the same or similar acts. For example, although FIG. 2A illustrates receiving sensory data from the user client device 114a, in some such embodiments, the transportation matching system 102, via the server(s) 104, also receives the same type of sensory data from other user client devices. This sensory data may include similar location data, accelerometer data, and gyroscopic data. Based on both the sensory data from the user client device 114a and the other user client devices (and the scheduling information from the mass-transit system 122), the transportation matching system 102 can determine that the user client device 114a and associated user 118a—as well as the other user client devices and associated users—are traveling within a train or other mass-transit vehicle.

As another example, although not illustrated in FIGS. 2A-2B, in some embodiments, the transportation matching system 102 also utilizes a user's travel history determine (at the step 208) that a user is currently traveling on a mass-transit vehicle. For example, the transportation matching system 102 may determine location data from the user client device 114a. The transportation matching system 102 may further analyze the user's travel history to determine that the user 118a previously used an airplane at a particular airport corresponding to the location data. Based on the sensory data and the user's travel history, the transportation matching system 102 determines that the user client device 114a and associated user 118a are traveling within an airplane at a particular airport (e.g., taxiing on a taxiway of the airport). A similar determination may be made for other mass-transit vehicles.

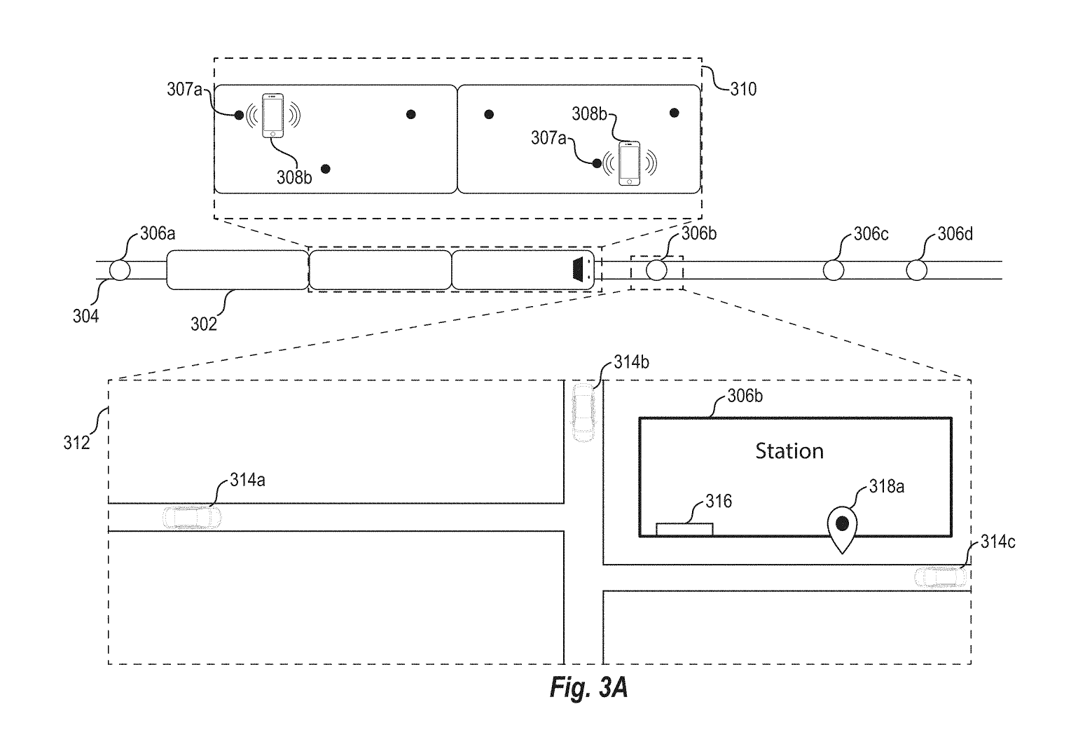

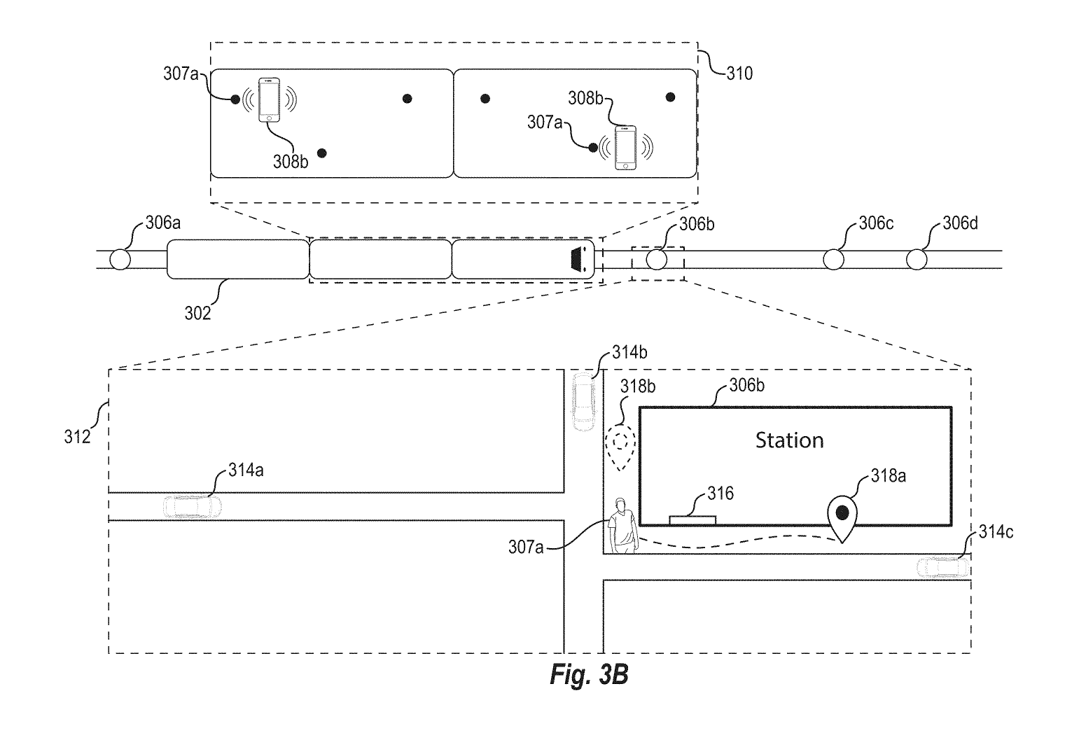

Turning now to FIGS. 3A-3B, these figures illustrate conceptual diagrams of the transportation matching system 102 determining a user is traveling on a mass-transit vehicle based on sensory data and then sending a transportation-request notification to a transportation vehicle for pickup of the user at a pickup location corresponding to a mass-transit station.

As shown in FIG. 3A, a mass-transit vehicle 302 transports a first user 307a associated with a first user client device 308a and a second user 307b associated with a second user client device 308b. The mass-transit vehicle 302 stops at a first mass-transit station 306a, a second mass-transit station 306b, a third mass-transit station 306c, and a fourth mass-transit station 306d along a travel route 304. As FIG. 3A indicates, the mass-transit vehicle 302 is traveling toward the second mass-transit station 306b.

FIG. 3A includes an enlarged view 310 that depicts some of the contents of the mass-transit vehicle 302. As indicated within the enlarged view 310, the first user client device 308a and the second user client device 308b send sensory data to the transportation matching system 102. In particular, the user client devices 308a and 308b each repeatedly send atmospheric data from a barometer and location data from a GPS receiver to the transportation matching system 102. The location data indicates the location of the user client devices 308a and 308b in longitudinal and latitudinal degrees. Based on multiple longitudinal and latitudinal degrees from the user client devices 308a and 308b, the transportation matching system 102 can determine a speed and direction of the user client devices 308a and 308b. The atmospheric data indicates an atmospheric pressure surrounding each of the user client devices 308a and 308b.

Although not shown in FIG. 3A, the transportation matching system 102 further receives scheduling information from a mass-transit system concerning arrivals and estimated times of arrival of the mass-transit vehicle 302 at the mass-transit stations 306a-306d. In particular, the mass-transit system sends an arrival time of the mass-transit vehicle 302 at the first mass-transit station 306a and estimated times of arrival of the mass-transit vehicle 302 at each of the second mass-transit station 306b, the third mass-transit station 306c, and the fourth mass-transit station 306d.

Based on the sensory data from the user client devices 308a and 308b and the scheduling information concerning the mass-transit vehicle 302, the transportation matching system 102 determines that the first user 307a and the second user 307b are traveling in the mass-transit vehicle 302. In particular, the transportation matching system 102 estimates a location, speed, and direction of the mass-transit vehicle 302 based on the arrival time and estimated arrival times from the mass-transit system. The transportation matching system 102 further determines that the location, speed, and direction of the user client devices 308a and 308b are consistent with the estimated location, speed, and direction of the mass-transit vehicle 302. In some embodiments, the transportation matching system 102 further determines that the atmospheric pressure surrounding the user client devices 308a and 308b is consistent with a range of atmospheric pressure expected within the mass-transit vehicle 302 (e.g., a range of atmospheric pressure within a subway train or a range of atmospheric pressure within an airplane).

In addition to determining the first user 307a is traveling within the mass-transit vehicle 302, the transportation matching system 102 also identifies a station as a potential exit point for the first user 307a. In particular, the transportation matching system 102 analyzes the travel history of the first user 307a stored within the transportation matching database 106. The transportation matching system 102 determines that the first user 307a previously used transportation vehicles departing from and/or arriving at the second mass-transit station 306b. Additionally, the transportation matching system 102 determines that the first user 307a regularly or periodically requests transportation vehicles from the transportation matching system 102 departing from and/or arriving at the second mass-transit station 306b. Accordingly, the transportation matching system 102 determines that the travel history of the first user 307a indicates that the first user 307a previously used mass-transit vehicles at the second mass-transit station 306b.

In addition to analyzing the travel history of the first user 307a, the transportation matching system 102 further determines that the mass-transit vehicle 302 is traveling toward the second mass-transit station 306b based on the location and direction of the mass-transit vehicle 302. The transportation matching system 102 may determine that the mass-transit vehicle 302 is traveling toward the second mass-transit station 306b either before, during, or after evaluating a travel history of the first user 307a. Relying on both the travel history of the first user 307a and the location and direction of the mass-transit vehicle 302, the transportation matching system 102 identifies the second mass-transit station 306b as an exit point for the first user 307a.

Independent of analyzing the travel history of the first user 307a, in certain embodiments, the transportation matching system 102 analyzes other users' travel histories to identify a station for the first user 307a. Consistent with the disclosure above, the transportation matching system 102 determines that the second user 307b and other users (not shown) previously used transportation vehicles—or regularly or periodically request transportation vehicles from the transportation matching system 102—departing from and/or arriving at the second mass-transit station 306b. Relying on the travel history of the first user 307a, the travel history of other users, and the location and direction of the mass-transit vehicle 302, in certain embodiments, the transportation matching system 102 identifies the second mass-transit station 306b as an exit point for the first user 307a.

In addition (or in the alternative) to analyzing other users' travel histories, in certain embodiments, the transportation matching system 102 analyzes historical use of exits at a station. For example, in some cases, the transportation matching system 102 determines that users of the transportation matching system 102 historically use—or request transportation from pickup locations near—a particular exit a certain percentage of total transportation requests within a threshold distance of the second mass-transit station 306b (e.g., 35% of users use a given exit at the second mass-transit station 306b). In some such embodiments, the transportation matching system 102 dispatches sufficient providers to locations around the particular exit to provide transportation to users traveling on the mass-transit vehicle 302 (e.g., by dispatching transportation vehicles to provide transportation to 35% of detected users traveling on the mass-transit vehicle 302).

In addition, or in the alternative to analyzing users' travel histories or historical exit usage, in some embodiments, the transportation matching system 102 identifies a station for a user based on a user's calendar. For example, in some implementations, the user client device 308a detects a selection by the first user 307a to grant the transportation matching system 102 permission to access calendar information stored on the user client device 308a. By accessing calendar information on the user client device 308a, the transportation matching system 102 identifies currently scheduled or upcoming calendar events corresponding to a location. In some embodiments, the calendar event identifies a location by name or address (e.g., a name of a sporting venue). In certain embodiments, the calendar event identifies a task that corresponds to a location (e.g., a calendar event for “work”). As for the latter embodiment, the transportation matching system 102 identifies a location corresponding to a task based on travel history (e.g., by identifying that the first user 307a travels to a particular location at a time corresponding to past calendar events of a same or similar calendar event). The transportation matching system 102 then identifies a station for the first user 307a corresponding to the location associated with the calendar event.

After identifying the second mass-transit station 306b for the first user 307a, the transportation matching system 102 also determines an estimated transit time of the first user 307a from a location of the mass-transit vehicle 302 to the second mass-transit station 306b. In some embodiments, the transportation matching system 102 determines an estimated transit time to the second mass-transit station 306b based on the location and speed of the user client device 308a (e.g., without considering sensory data from other user client devices or scheduling information). In some embodiments, the transportation matching system 102 determines an estimated transit time of the first user 307a from a location of the mass-transit vehicle 302 to the second mass-transit station 306b based on the estimated time of arrival of the mass-transit vehicle 302 from the mass-transit system.

In certain embodiments, the transportation matching system 102 averages or combines estimated transit times. First, based on the location and speed of the user client devices 308a and 308b, the transportation matching system 102 determines an estimated transit time to the second mass-transit station 306b for each of the first user 307a and the second user 307b. Second, based on the scheduling information from the mass-transit system, the transportation matching system 102 further determines an estimated transit time of the mass-transit vehicle 302 to the second mass-transit station 306b. The transportation matching system 102 then averages the estimated transit time for each of the first user 307a and the second user 307b (based on sensory data) and the mass-transit vehicle 302 (based on scheduling information) to determine an estimated transit time of the first user 307a from a location of the mass-transit vehicle 302 to the second mass-transit station 306b. In this manner, the transportation matching system 102 may account for instances where the scheduling information for the mass-transit vehicle 302 is inaccurate.

The transportation matching system 102 can also determine a weighted average of the estimated transit time of each of the first user 307a, the second user 307b, and the mass-transit vehicle 302 to determine an estimated transit time of the first user 307a from a location of the mass-transit vehicle 302 to the second mass-transit station 306b. In some such embodiments, the transportation matching system 102 applies a greater weight to the estimated transit time derived from the first user client device 308a—which is the user client device associated with the user for whom the transportation matching system 102 is determining the estimated transit time. In this example, the transportation matching system 102 would weight the estimated transit time for the first user 307a more heavily (e.g., with a greater percentage).

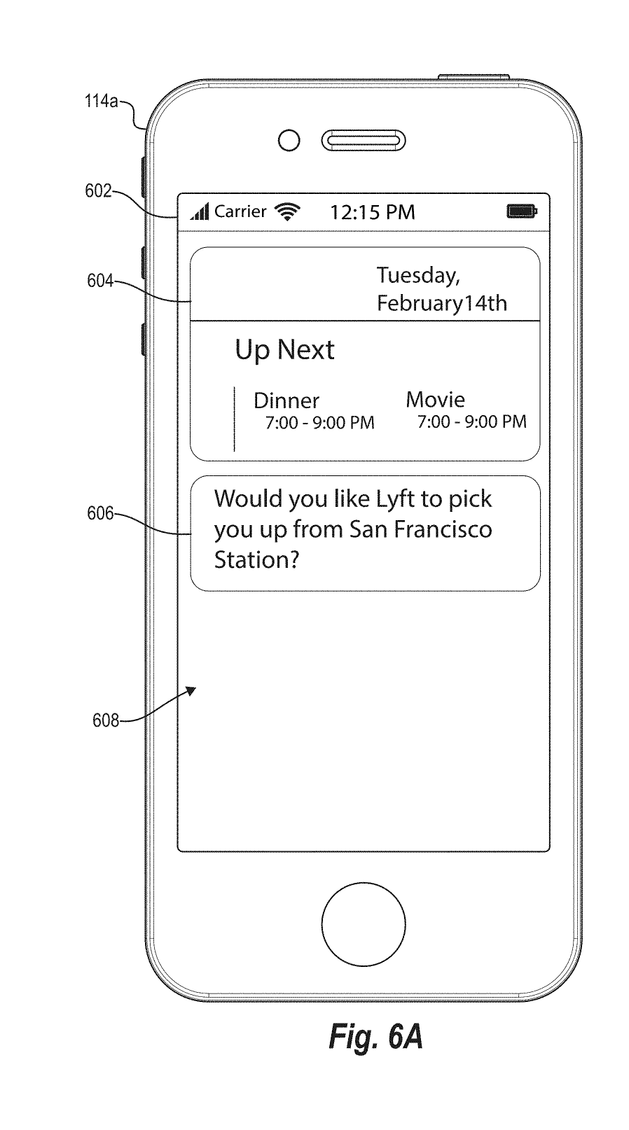

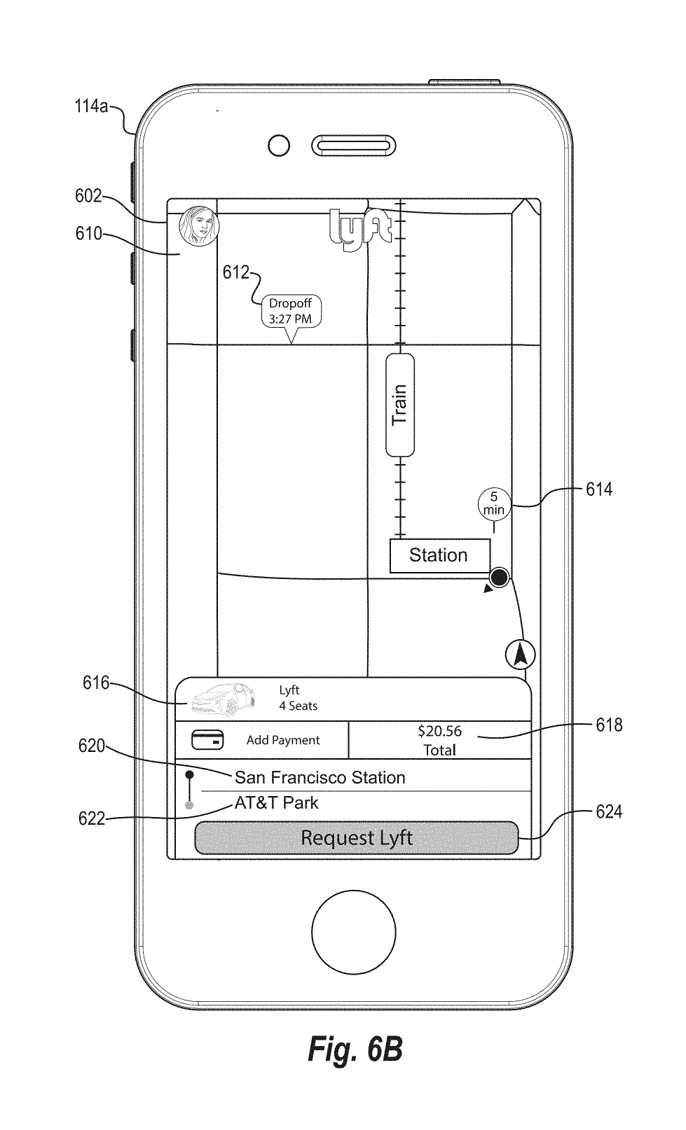

After determining an estimated transit time for the first user 307a, the transportation matching system 102 optionally provides the first user 307a with a selectable option for requesting transport. Although not shown in FIG. 3A, the transportation matching system 102 sends the first user client device 308a a push notification suggesting that the first user 307a request a transportation vehicle from the transportation matching system 102 departing from the second mass-transit station 306b. If the first user 307a selects the push notification, the first user client device 308a sends an indication of the selection to a server (e.g., the server(s) 104). The transportation matching system 102 in turn sends the first user client device 308a a transportation-request option for presentation to the first user 307a. When the first user 307a selects the transportation-request option, the first user client device 308a sends a transportation request to a server. FIGS. 6A and 6B below depict an example of such push notifications and transportation-request options.

In addition to determining an estimated transit time for the first user 307a and/or receiving a transportation request, the transportation matching system 102 determines a pickup location and selects a transportation vehicle to receive a transportation-request notification for pickup of the first user 307a. As further shown in FIG. 3A, an enlarged view 312 depicts certain surroundings of the second mass-transit station 306b. FIG. 3A includes a pickup location 318a within the enlarged view 312. The transportation matching system 102 selects the pickup location 318a as a pickup location for the first user 307a based on its distance from an exit 316 of the second mass-transit station 306b (and/or its visibility from a transportation vehicle traveling on the road).

In some embodiments, the transportation matching system 102 selects the pickup location 318a because it is a landmark (e.g., a building, a sign, a statute). Additionally, or alternatively, in certain embodiments, the transportation matching system 102 selects the pickup location 318a because it is nearby an exit determined closest to the first user 307a's location within the mass-transit vehicle 302 (e.g., an exit closest to a platform corresponding to the first user 307a's location within the mass-transit vehicle 302). Moreover, in some embodiments, the transportation matching system 102 selects the pickup location 318a because the pickup location 318a is within a threshold distance of an exit with less traffic (e.g., a lower percentage of users use the exit 316). By contrast, in certain embodiments, the transportation matching system 102 selects the pickup location 318a because the pickup location 318a is closer by a measure of distance to a destination or is associated with a shorter estimated transit time to a destination. Alternatively, in some implementations, the transportation matching system 102 selects the pickup location 318a because the pickup location 318a receives a more favorable user-pickup experience than an alternative pickup location (e.g., based on an average pickup score from users measuring amount of waiting time for pickup and/or density of people surrounding the pickup location).

As further shown within the enlarged view 312, a first transportation vehicle 314a, a second transportation vehicle 314b, and a third transportation vehicle 314c are located different distances from the second mass-transit station 306b. The transportation matching system 102 determines an estimated transit time for each of the transportation vehicles 314a-314c based on location data from GPS receivers of their associated provider client devices. Based on the estimated transit times for the transportation vehicles 318a-314c, the transportation matching system 102 selects the third transportation vehicle 314c to receive a transportation-request notification. As indicated by FIG. 3A, the transportation matching system 102 sends a transportation-request notification to a provider client device associated with the third transportation vehicle 314c. The transportation-request notification indicates the pickup location 318a and an estimated time of arrival for the first user 307a.

Turning back now to FIG. 3B, in addition to determining an estimated transit time of a user from a location of a mass-transit vehicle to a station, the transportation matching system 102 optionally determines an estimated transit time of the user from a station to a pickup location. To determine such an estimated transit time, the transportation matching system 102 optionally determines one or both of a location of a user within a mass-transit vehicle and an average traveling speed of a user in a given station. FIG. 3B provides an example of such a determination.

As shown in the enlarged view 312, FIG. 3B depicts the first user 307a near the second mass-transit station 306b. To determine an estimated transit time of the first user 307a from the second mass-transit station 306b to the pickup location 318a, in some embodiments, the transportation matching system 102 determines a location of the first user 307a within the mass-transit vehicle 302 based on the sensory data.

For example, as shown in FIG. 3B, the location data from the GPS receiver of the first user client device 308a indicates that the first user 307a is within a particular part of the mass-transit vehicle 302 (e.g., a second car of a train). The transportation matching system 102 then correlates the location of the first user client device 308a within the mass-transit vehicle 302 with a location at the second mass-transit station 306b (e.g., a particular platform within a train station that the user will use upon exiting the second car of the train). The transportation matching system 102 can then determine a transit time from the location at the second mass-transit station 206b (e.g., the particular platform where the user with exit) and a pickup location.

The transportation matching system 102 can also determine transit time based on an amount of time to exit a mass-transit vehicle. For example, the transportation matching system 102 can determine a location of a client device within a mass-transit vehicle and then determine an amount of time to exit the mass-transit vehicle from the location (e.g., a five-minute wait time to exist from the back of an airplane). In certain embodiments, the transportation matching system 102 determines transit time based on an amount of time for a user to exit a particular mass-transit vehicle. For instance, the transportation matching system 102 may communicate with the mass-transit system to identify a type for the mass-transit vehicle 302 and identify whether the type of mass-transit vehicle 302 typically provides access (or is within proximity to) a particular exit. For example, a particular train or airplane may typically arrive near a particular exit or, alternatively, a train with a particular number of cars may have cars closer to one exit than another exit.

In addition to determining a location of the user at a station or an exit time, the transportation matching system 102 can also identify an average user traveling speed for a particular user (e.g., the first user 307a). For example, in some embodiments, the transportation matching system 102 determines an average user traveling speed for the first user 307a based on location data from the GPS receiver of the user client device 308a. When the first user 307a has selected options to allow tracking location data, the transportation matching system 102 can use average user traveling speed with location data. For instance, in some such embodiments, the transportation matching system 102 tracks a location and a transit time of the first user 307a from a mass-transit vehicle to a pickup location. The transportation matching system 102 stores such transit data as part of the travel history of the first user 307a. Based on the location data and transit times, the transportation matching system 102 determines an average user traveling speed for the first user 307a.

Similarly, in certain embodiments, the transportation matching system 102 identifies an average user traveling speed for a particular mass-transit station. For example, in some embodiments, the transportation matching system 102 determines an average user traveling speed for the second mass-transit station 306b based on location data and transit times of users that visit the second mass-transit station 306b. In some such embodiments, the transportation matching system 102 uses location data and transit times of users traveling from a mass-transit vehicle to a particular pickup location corresponding to the second mass-transit station 306b. Additionally, or alternatively, the transportation matching system 102 uses location data and transit times of users traveling generally within the second mass-transit station 306b.

The transportation matching system 102 can also determine and utilize a pre-determined traveling speed based on a type of mass-transit station. For example, the transportation matching system 102 may determine or set a lower average user traveling speed for crowded mass-transit stations (e.g., Grand Central Station in New York, N.Y.) than for less crowded mass-transit stations (e.g., Caltrain's Lawrence station in Sunnyvale, Calif.). In the alternative, the transportation matching system 102 can use an average user traveling speed (e.g., 3.1 miles per hour for walking) as a pre-determined default for a mass-transit station. In some such embodiments, the transportation matching system 102 determines an average user traveling speed based on historical travel times of users within a particular mass-transit station. For example, the transportation matching system 102 may determine an average travel time for users traveling from a mass-transit vehicle to pickup locations associated with a mass-transit station (e.g., for an airport where users collect baggage and walk to a curb).

Based on the location of the first user client device 308a within the mass-transit vehicle 302 and an average user traveling speed, the transportation matching system 102 determines an estimated transit time of the first user 307a from the second mass-transit station 306b to the pickup location 318a. In particular, the transportation matching system 102 multiplies (i) a distance between the second mass-transit station 306b to the pickup location 318a and (ii) an average user traveling speed for the first user 307a to determine an estimated transit time of the first user 307a from the second mass-transit station 306b to the pickup location 318a. Alternatively, the transportation matching system 102 uses an average user traveling speed for the second mass-transit station 306b or for people generally to determine an estimated transit time of the first user 307a.

In some such embodiments, the transportation matching system 102 uses an aggregate estimated transit time of the first user 307a from a location of the mass-transit vehicle 302 to the pickup location 318a to select a transportation vehicle. In particular, the transportation matching system 102 compares (i) the aggregate estimated transit time of the first user 307a from a location of the mass-transit vehicle to the pickup location 318a with (ii) the estimated transit time for each of the transportation vehicles 318a-314c. Based on the estimated transit times for the transportation vehicles 318a-314c and the aggregate estimate transit time of the first user 307a, the transportation matching system 102 selects a transportation vehicle to receive a transportation-request notification, such as by selecting the third transportation vehicle 314c.

Independent of estimating transit time, in certain embodiments, the transportation matching system 102 provides guidance to users traveling from a mass-transit vehicle to a pickup location. For example, in certain embodiments, the user client device 308b includes a user application that provides a map of the second mass-transit station 306b. Based on the detected location of the first user 307a, the transportation matching system 102 sends travel instructions to the user client device 308b for traveling from the first user 307a's current location to the pickup location 318a or the alternative pickup location 318b.

In addition to initially selecting a transportation vehicle, the transportation matching system 102 optionally changes a selection of a transportation vehicle or a pickup location based on additional inputs from a user client device. For example, in some embodiments, the user client device 308a sends updated sensory data to the transportation matching system 102 indicating that the first user 307a has changed locations within the mass-transit vehicle 302. Additionally, or alternatively, the first user client device 308a sends a destination (or an updated destination) to the transportation matching system 102 as part of a transportation request (or an updated transportation request). Based on the changed location and/or changed destination, in some embodiments, the transportation matching system 102 changes one or both of a pickup location and a transportation vehicle.

As shown in FIG. 3B, for instance, the transportation matching system 102 changes a pickup location and a selection of a transportation vehicle. Based on receiving updated sensory data indicating the first user 307a has changed locations within the mass-transit vehicle 302 and changed a destination in an updated transportation request, the transportation matching system 102 sends an updated transportation confirmation to the first user client device 308a indicating an alternative pickup location 318b. The updated transportation confirmation also indicates a different provider for transport—that is, a provider associated with the second transportation vehicle 314b.

In addition, or in the alternative to changing a pickup location, in some embodiments, the transportation matching system 102 suggests to a user an alternative mass-transit station from which to exit a mass-transit vehicle. For instance, in some embodiments, based on receiving an updated destination in an updated transportation request from the first user client device 308a, the transportation matching system 102 determines that a transportation vehicle transporting the first user 307a from the third mass-transit station 306c (instead of the second mass-transit station 306b) is likely to result in a shorter transit time to the updated destination. Accordingly, the transportation matching system 102 sends a transportation proposal to the first user client device 308a suggesting that the first user 307a exit at the third mass-transit station 306c and use a different provider and pickup location.

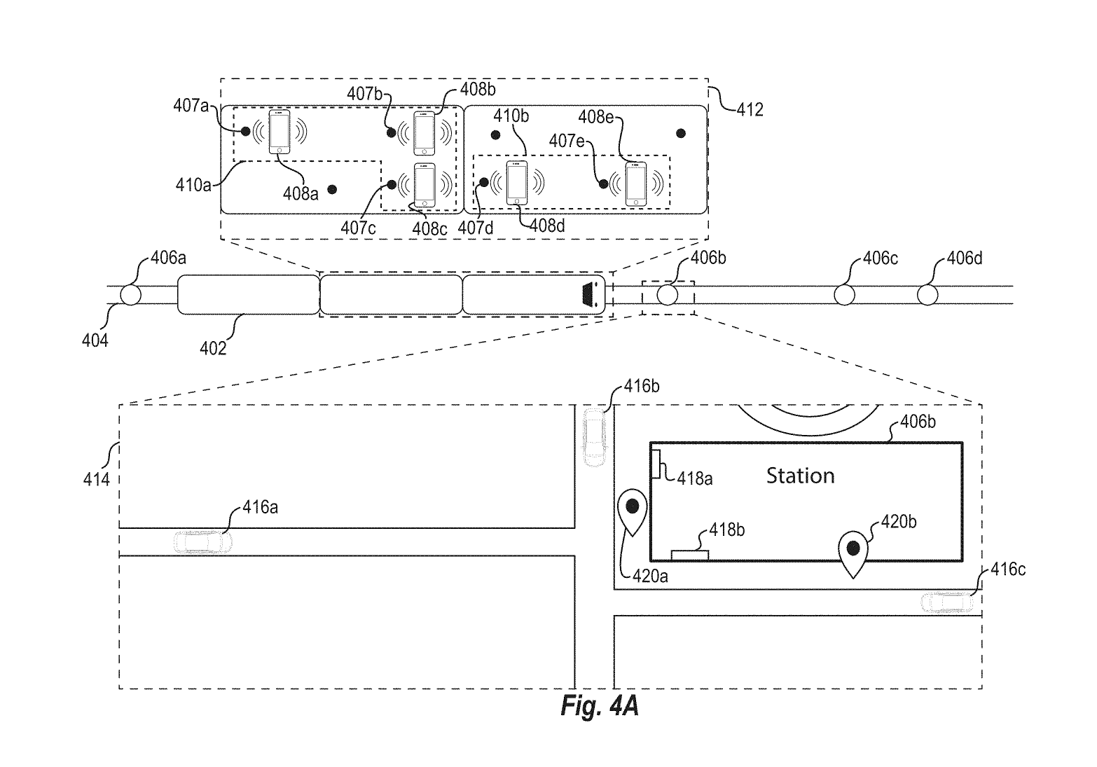

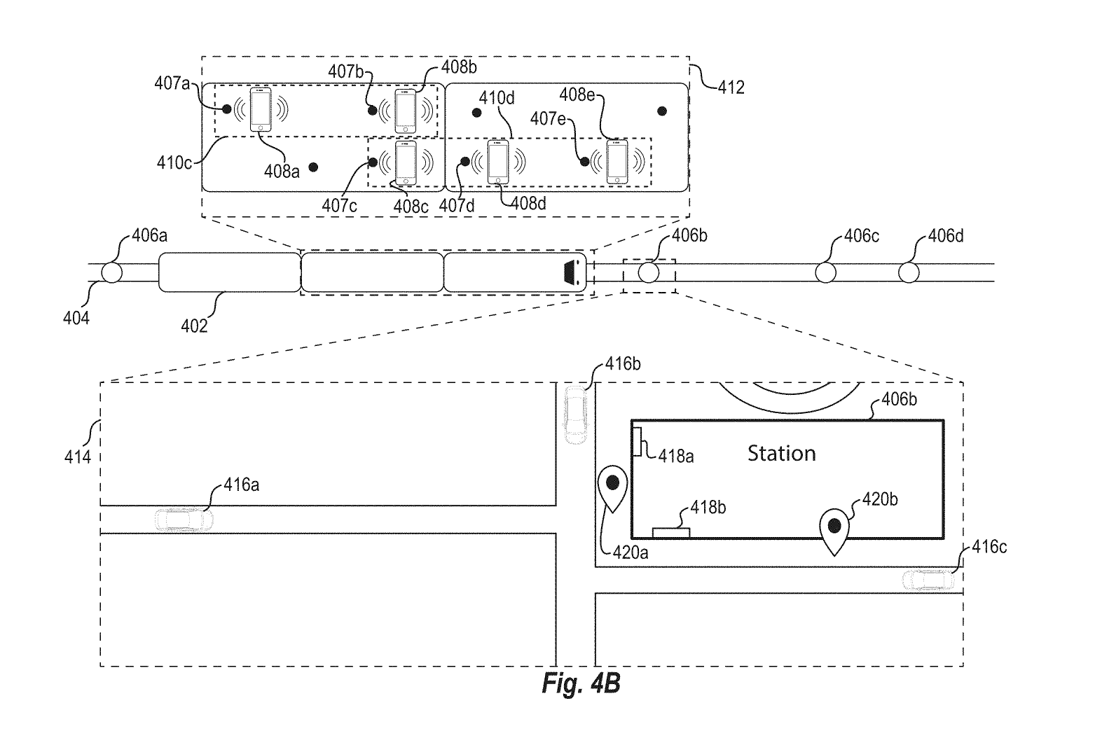

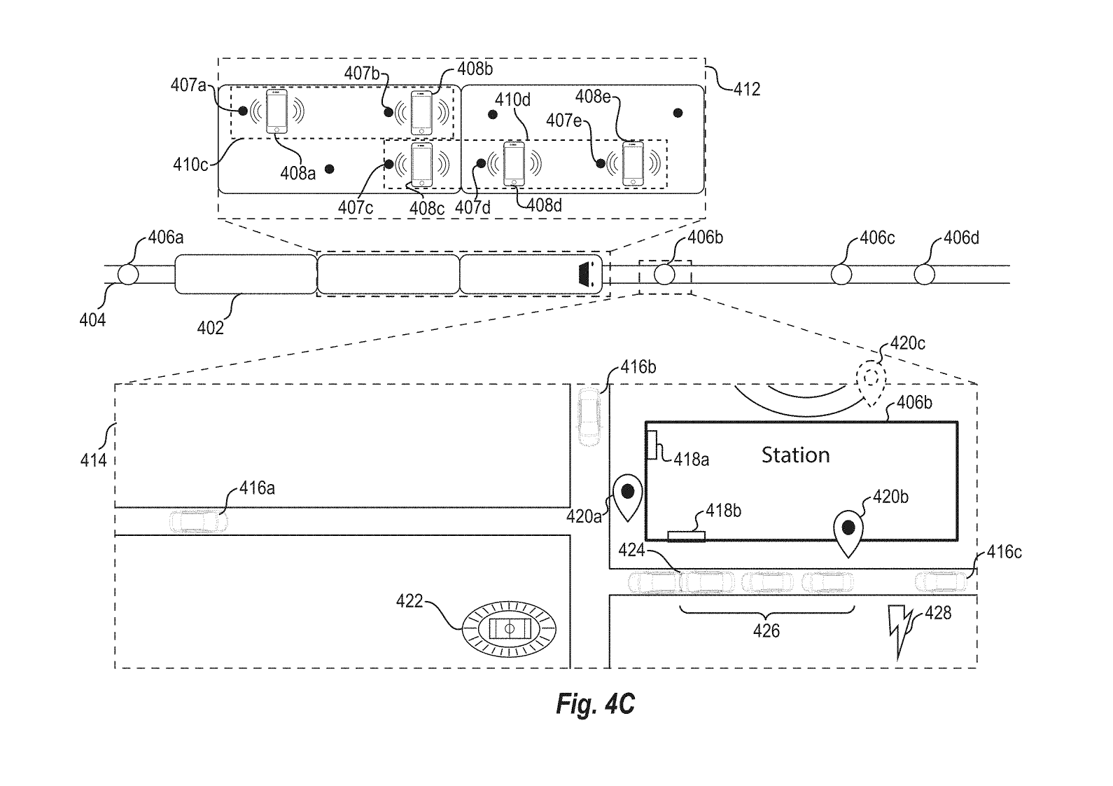

Turning now to FIGS. 4A-4C, these figures illustrate conceptual diagrams of the transportation matching system 102 creating groups of users who are traveling on a mass-transit vehicle and sending transportation-request notifications to transportation vehicles for pickup of user groups at pickup locations corresponding to a mass-transit station. By creating groups of users who are traveling on a mass-transit vehicle—and matching user groups with transportation vehicles—the transportation matching system 102 reduces wait times and request queues at mass-transit stations and decreases the number of transportation vehicles dispatched to a given mass-transit station. In particular, FIG. 4A illustrates the transportation matching system 102 creating user groups for transport by different transportation vehicles based on transit characteristics of individual users. FIG. 4B illustrates the transportation matching system 102 reorganizing user groups based on updated transit characteristics. FIG. 4C illustrates the transportation matching system 102 changing pickup locations or suggesting alternative mass-transit stations for users to exit based on a disruption event.

As shown in FIG. 4A, a mass-transit vehicle 402 transports users associated with user client devices along a travel route 404. A first user 407a, a second user 407b, a third user 407c, a fourth user 407d, and a fifth user 407e are respectively associated with a first user client device 408a, a second user client device 408b, a third user client device 408c, a fourth user client device 408d, and a fifth user client device 408e. The mass-transit vehicle 402 stops at a first mass-transit station 406a, a second mass-transit station 406b, a third mass-transit station 406c, and a fourth mass-transit station 406d along the travel route 404. As FIG. 4A indicates, the mass-transit vehicle 402 is traveling toward the second mass-transit station 406b.

As indicated within an enlarged view 412 of the mass-transit vehicle 402's contents, the user client devices 408a-408e send sensory data to the transportation matching system 102. Consistent with the disclosure above, the transportation matching system 102 determines that the users 407a-407e are traveling in the mass-transit vehicle 402 based on the sensory data from the user client devices 408a-408e. The transportation matching system 102 further identifies the second mass-transit station 406b as a potential exit point for the users 407a-407e based on the sensory data from the user client devices 408a-408e, the respective travel histories of the users 407a-407e, and scheduling information from a mass-transit system.

After identifying the second mass-transit station 406b for the users 407a-407e, the transportation matching system 102 sends push notifications to some or all of the user client devices 408a-408e suggesting that users request a transportation vehicle departing from the second mass-transit station 406b. In some embodiments, the transportation matching system 102 also suggests (in push notifications and/or selectable transportation-request options) that the users 407a-407e select a transportation vehicle that transports multiple users. In response to user interactions (e.g., with the push notification and/or transportation-request options), each of the user client devices 408a-408e send transportation requests to the transportation matching system 102. For purposes of explaining FIG. 4A, each of the transportation requests indicate a selection of a transportation vehicle that transports multiple users (although the transportation matching system can generate transportation requests and/or groups without user selection of a transportation vehicle that supports multiple users). In some embodiments, the transportation requests indicate a destination to which the user requests transport.

Upon or before receiving the transportation requests from the users 407a-407e, the transportation matching system 102 determines one or more transit characteristics of the users 407a-407e for creating user groups. The transit characteristics may include, but are not limited to, a location of each of the users 407a-407e within the mass-transit vehicle 402, an estimated transit time (e.g., transit time from the second mass-transit station 406b to a pickup location for each of the users 407a-407e), a destination indicated by a transportation request from each of the user client devices 408a-408e or determined by the transportation matching system 102, a travel speed for each of the users 407a-407e, or transportation-companion preferences of the users 407a-407e.

For example, with regard to estimated transit time, in some embodiments, the transportation matching system 102 determines a location of each of the users 407a-407e within the mass-transit vehicle 402 based on sensory data from the user client devices 408a-408e. Consistent with the disclosure above, the transportation matching system 102 determines an estimated transit time from the second mass-transit station 406b to one or more potential pickup locations based on the location of each of the users 407a-407e within the mass-transit vehicle 402. Such potential pickup locations include, but are not limited to, pickup locations the transportation matching system 102 has previously used for a mass-transit station, landmarks by the mass-transit station, or pickup locations by specific exits of the mass-transit station.

After determining one or more transit characteristics of the users 407a-407e, the transportation matching system 102 analyzes the one or more transit characteristics to create user groups from among the users 407a-407e. In certain embodiments, the transportation matching system 102 creates user groups based on one or more of a location of each of the users 407a-407e within the mass-transit vehicle 402; an estimated transit time from the station to the pickup location for each of the users 407a-407e; a destination indicated by a transportation request from each of the user client devices 408a-408e; a travel speed for each of the users 407a-407e; or transportation-companion preferences of the users 407a-407e.

For example, in some embodiments, the transportation matching system 102 creates user groups based on the relative proximity of the users 407a-407e within the mass-transit vehicle 402. When creating user groups based on relative proximity, the transportation matching system 102 may determine that the relative proximity of some of the users 407a-407e facilitates creating user groups of users who are already familiar with each other. Alternatively, the transportation matching system 102 may determine that the relative proximity of some of the users 407a-407e facilitates such users arriving at a pickup location within a relatively closer time period than if grouped with some of the other users 407a-407e.

Similarly, in some embodiments, the transportation matching system 102 creates user groups based on the relative estimated transit times of the users 407a-407e to one or more pickup locations. When creating user groups based on estimated transit times, the transportation matching system 102 may determine that the relative estimated transit times of the users 407a-407e facilitates such users arriving at a pickup location within a relatively closer time period than if grouped with some of the other users 407a-407e.

As another example, the transportation matching system 102 optionally creates user groups based on the destination indicated by each of the transportation requests from the user client devices 408a-408e. Accordingly, in some embodiments, the transportation matching system 102 creates user groups of users who have indicated destinations in a similar direction relative to destinations indicated by other users within the mass-transit vehicle 402. Additionally, or alternatively, the transportation matching system 102 uses destinations indicated by travel histories for one or more of the users 407a-407e. In some such embodiments, the transportation matching system 102 creates user groups based on a combination of (a) destinations indicated by users in a similar direction relative to destinations indicated by other users within the mass-transit vehicle 402 and (b) destinations indicated by travel histories for one or more of the users 407a-407e. For instance, the transportation matching system 102 may rely on destinations indicated by users as a default and (if a user has not indicated a destination) rely on a destination indicated by a travel history.

In addition or in the alternative to location, estimated travel times, or destinations, the transportation matching system 102 optionally creates user groups based on user selections. In some embodiments, for example, the transportation matching system 102 presents a transportation-companion field via a user client device. By detecting user input in the transportation-companion field, a user client device receives names of users with whom a user would like to be grouped with or from whom a user would like to be separated from in a different transportation vehicle. Further, the transportation matching system 102 can track users with whom a user has previously shared a ride and may use the ratings from that ride to determine whether the user and other users are suitable to be grouped within a user group. Accordingly, the transportation matching system 102 may create a user group of users who have indicated they would like to be part of a same user group—that is, share transportation in a same transportation vehicle.

In addition or in the alternative to the transit characteristics described above, the transportation matching system 102 optionally creates user groups based on average user traveling speed. For example, in certain embodiments the transportation matching system 102 creates user groups comprising users with relatively slower average user traveling speeds and user groups comprising users with relatively higher average user traveling speeds.

As shown in FIG. 4A, the transportation matching system 102 creates a user group 410a and a user group 410b based on the relative proximity of the users 407a-407e. In particular, the transportation matching system 102 creates the user group 410a because the users 407a, 407b, and 407c are in closer proximity to each other than the users 407d and 407e are to the users 407a, 407b, and 407c. Similarly, the transportation matching system 102 creates the user group 410b because the users 407d and 407e are in closer proximity to each other than the users 407a, 407b, and 407c are to the users 407d and 407e. As shown in FIG. 4A, the users 407a, 407b, and 407c are within one section of the mass-transit vehicle 402 and the users 407d and 407e are within another section of the mass-transit vehicle 402 (e.g., different cars of a train).

The transportation matching system 102 can also create the user group 410a and the user group 410b based on the destinations indicated in transportation requests from the user client devices 408a-408e. In particular, the transportation matching system 102 creates the user group 410a because the transportation requests of the users 407a, 407b, and 407c indicate destinations for a transportation vehicle in a same or similar direction relative to the destinations indicated by the transportation requests of the users 407d and 407e. Similarly, the transportation matching system 102 creates the user group 410b because the transportation requests of the users 407d and 407e indicate destinations for a transportation vehicle in a same or similar direction relative to the destinations indicated by the transportation requests of the users 407a, 407b, and 407c. As shown in FIG. 4A, for example, the transportation requests of the users 407a, 407b, and 407c may indicate destinations to the north or east of the second mass-transit station 406b while the transportation requests of the users 407d and 407e may indicate destinations to the south or west of the second mass-transit station 406b.

After creating user groups, the transportation matching system 102 determines pickup locations for each user group. For example, the transportation matching system 102 may determine a pickup location for a user group based on a relative proximity to one or both of an exit for a mass-transit station and the locations of user groups (or their constituent users) within a mass-transit vehicle. Additionally, the transportation matching system 102 may determine a pickup location for a user group by selecting a landmark or recognizable location nearby the mass-transit station or a particular exit of the mass-transit station.

As shown in FIG. 4A, the transportation matching system 102 determines a pickup location 420a for the user group 410a and a pickup location 420b for the user group 410b. In particular, the transportation matching system 102 determines that the users 407a, 407b, and 407c will be relatively closer to an exit 418a of the second mass-transit station 406b than to an exit 418b of the second mass-transit station 406b upon arrival of the mass-transit vehicle 402. The transportation matching system 102 selects the pickup location 420a for the user group 410a in part because the pickup location 420a represents a landmark nearby the exit 418a (e.g., a well-known building, fountain, or statue). Similarly, the transportation matching system 102 determines that the users 407d and 407e will be relatively closer to the exit 418b of the second mass-transit station 406b than to the exit 418a of the second mass-transit station 406b upon arrival of the mass-transit vehicle 402. The transportation matching system 102 selects the pickup location 420b for the user group 410b in part because the pickup location 420b represents a recognizable location nearby the exit 418b (e.g., an intersection of roads, a kiss-and-ride, a pick-up area for a train station or airport).

In addition to selecting a pickup location for the user groups, the transportation matching system 102 also selects a transportation vehicle to receive a transportation-request notification for users of each user group. As shown within an enlarged view 414, a first transportation vehicle 416a, a second transportation vehicle 416b, and a third transportation vehicle 416c are located different distances from the second mass-transit station 406b. The transportation matching system 102 determines an estimated transit time for each of the transportation vehicles 416a-416c based on location data from GPS receivers of the transportation vehicles' associated provider client devices and routing information (e.g., estimated time of arrival incorporating different routes, traffic, etc.) from the location data to the pickup location. Based on the estimated transit times for the transportation vehicles 416a-416c, the transportation matching system 102 selects the second transportation vehicle 416b to receive one or more transportation-request notifications for users within the user group 410a. Similarly, the transportation matching system 102 selects the third transportation vehicle 416c to receive one or more transportation-request notifications for users within the user group 410b.

As indicated by FIG. 4A, the transportation matching system 102 sends one or more transportation-request notifications to a provider client device associated with the second transportation vehicle 416b (corresponding to the user group 410a) and to a provider client device associated the third transportation vehicle 416c (corresponding to the user group 410b). A transportation-request notification for the second transportation vehicle 416b indicates the pickup location 420a, a transportation type for multiple users, and optionally an estimated time of arrival for each user within the user group 410a. Similarly, a transportation-request notification for the third transportation vehicle 416c indicates the pickup location 420b, a transportation type for multiple users, and optionally an estimated time of arrival for each user within the user group 410b.

Turning back now to FIG. 4B, as noted above, in some embodiments, the transportation matching system 102 reorganizes user groups as transit characteristics or circumstances change. By reorganizing user groups, the transportation matching system 102 dynamically matches users and user groups with transportation vehicles to reduce the number of transportation vehicles dispatched to a given mass-transit station. As shown in FIG. 4B, the transportation matching system 102 reorganizes user groups upon determining updated transit characteristics for one or more of the users 407a-407e. In particular, the transportation matching system 102 reorganizes the user groups 410a and 410b to create user groups 410c and 410d.

As depicted in FIG. 4B, the user client devices 408a-408e continue to send sensory data (or updated transportation requests) to the transportation matching system 102. In particular, the transportation matching system 102 receives updated sensory data from each of the user client devices 408a-408e. In some cases, the updated sensory data includes information relevant to the transit characteristics of one or more of the users 407a-407e. For example, one of the user client devices 408a-408e may send updated location data from a GPS receiver indicating one of the users 407a-408e has changed locations within the mass-transit vehicle 402 relative to the other users. Moreover, in some embodiments, one of the user client devices 408a-408e may send an updated transportation request with an updated destination for transport or indicate a destination in the first instance for one of the users 407a-408e.

After receiving the updated sensory data or transportation requests, the transportation matching system 102 optionally determines updated transit characteristics for one or more of the users 407a-407e. For example, the transportation matching system 102 may determine an updated location of one or more of the users 407a-407e relative to each other within the mass-transit vehicle 402. As another example, the transportation matching system 102 may determine an updated destination for one or more of the users 407a-407e.

As shown in FIG. 4B, the transportation matching system 102 receives an updated transportation request from the user client device 408c indicating an updated destination for the third user 407c. Based on the updated destination, the transportation matching system 102 reorganizes the user groups 410a and 410b. In particular, the transportation matching system 102 creates the user group 410c and the user group 410d. The user group 410c includes the users 407a and 407b. By contrast, the user group 410d includes the users 407c, 407d, and 407e.

As shown in FIG. 4B, the transportation matching system 102 creates the user group 410c because the most recent transportation requests of the users 407a and 407b (either updated or initial transportation requests) indicate destinations for a transportation vehicle in a same or similar direction relative to the destinations indicated by the most recent transportation requests of the users 407c, 407d, and 407e. Similarly, the transportation matching system 102 creates the user group 410d because the transportation requests of the users 407c, 407d, and 407e indicate destinations for a transportation vehicle in a same or similar direction relative to the destinations indicated by the transportation requests of the users 407a and 407b.

In addition to reorganizing user groups, in some embodiments, the transportation matching system 102 also changes one or both of a pickup location and a transportation vehicle for a user group. For example, upon determining that the destination for the third user 407c has changed, the transportation matching system 102 may change the pickup location for the user group 410d to the pickup location 420a (instead of the pickup location 420b). Based on the updated destination for the third user 407c, the transportation matching system 102 may also change its selection of a transportation vehicle to the first transportation vehicle 416a (instead of the third transportation vehicle 416c). In certain embodiments, the transportation matching system 102 makes similar changes to one or both of a pickup location and a transportation vehicle for a user group based on changes to a user's location within a mass-transit vehicle.

Regardless of whether a pickup location or transportation vehicle changes, the transportation matching system 102 optionally sends updated or new transportation-request notifications to transportation vehicles and updated transportation confirmations to user client devices associated with a reorganized user group. As shown in FIG. 4B, for example, the transportation matching system 102 sends an updated transportation-request notification to a provider client device associated with the first transportation vehicle 416a for pickup of the users 407c, 407d, and 407d at the pickup location 420a. Moreover, the transportation matching system 102 sends an updated transportation-request notification to a provider client device associated with the second transportation vehicle 416b for pickup of the users 407a and 407b at the pickup location 420a. The transportation matching system 102 also sends a transportation-request cancellation to the provider client device associated with the third transportation vehicle 416c cancelling the transportation request for a user group with respect to the third transportation vehicle 416c.

When a pickup location or provider changes for a user, the transportation matching system 102 optionally also sends an updated transportation confirmation to an affected user's client device. In FIG. 4B, for example, the transportation matching system 102 sends updated transportation confirmations to the user client devices 408c, 408d, and 408e indicating a change in pickup location to the pickup location 420a and a change in provider to the provider associated with the first transportation vehicle 416a.

Turning back now to FIG. 4C, as suggested above, in some embodiments, the transportation matching system 102 detects or receives notifications of disruption events. As used in this disclosure, the term “disruption event” refers to an event that potentially hinders or delays a transportation vehicle from picking up, transporting, or dropping off a user. For example, a disruption event includes, but is not limited to, a publicly scheduled event near a mass-transit station, a vehicular accident near a mass-transit station, vehicular traffic near a mass-transit station, and a weather event near a mass-transit station (e.g., icy conditions, derecho, lightening, flood, rain, snow, storm, tornado). The transportation matching system 102 optionally monitors or pulls data from software applications, Rich Site Summary (“RSS”) feeds, or websites of news organizations, venues, weather organizations, or mass-transit systems to detect disruption events.

In some embodiments, the transportation matching system 102 determines a pickup location for a user or a user group in the first instance based on receiving notification of a disruption event. Similarly, in certain embodiments, the transportation matching system 102 suggests or changes an alternative pickup location to a user or a user group based on receiving notification of a disruption event. Additionally, or alternatively, in certain embodiments, the transportation matching system 102 suggests to a user or user group an alternative mass-transit station from which to exit a mass-transit vehicle.

As shown in FIG. 4C, the transportation matching system 102 receives a notification of a disruption event. FIG. 4C depicts four alternative examples of a disruption event, including a publicly scheduled event 422, a vehicular accident 424, vehicular traffic 426, and a weather event 428. The transportation matching system 102 receives notification of the publicly scheduled event 422 from the website of a venue near the second mass-transit station 406b, including start and end times of the publicly scheduled event 422. The publicly scheduled event 422 may be a ceremony, concert, parade, sporting event, or some other event. The transportation matching system 102 receives notification of the vehicular accident 424 or the vehicular traffic 426 from a software application or website of a news organization or regional transportation department (e.g., a city, province, or state department of transportation). Moreover, the transportation matching system 102 receives notification of the weather event 428 from a software application, RSS feed, or website of a mass-transit system, weather organization, or regional transportation department.

Based on receiving notification of one of the disruption events, the transportation matching system 102 either determines a pickup location in the first instance for a user group (or individual user) or changes a pickup location for a user group (or individual user). As shown in FIG. 4C, the transportation matching system 102 changes the pickup location for the user groups 410c and 410d to an alternative pickup location 420c. Accordingly, the transportation matching system 102 sends updated transportation-request notifications to the provider client devices associated with the transportation vehicles 416a and 416b indicating the alternative pickup location 420c. Similarly, the transportation matching system 102 sends updated transportation confirmations to the user client devices 408a-408e indicating the alternative pickup location 420c. Although not depicted in FIG. 4C, in some embodiments, the transportation matching system 102 also changes transportation vehicles for a user or user group in response to receiving notification of a disruption event.

In addition (or in the alternative) to changing a pickup location, in some embodiments, the transportation matching system 102 suggests to a user group (or individual user) an alternative mass-transit station from which to exit a mass-transit vehicle. In some embodiments, the transportation matching system 102 suggests an alternative mass-transit station only when the users in a user group have chosen to be part of a user group (e.g., using a transportation-companion preference). For instance, in some embodiments, based on receiving a notification of a disruption event, the transportation matching system 102 sends a transportation proposal to one or more of the user client devices 408a-408e suggesting that the users exit at the third mass-transit station 306c and use a different provider and pickup location.

Regardless of whether suggesting one or both of an alternative pickup location or an alternative mass-transit station, the transportation matching system 102 optionally provides user client devices with a selectable option to change one or both of a pickup location or mass-transit station from which to exit. For example, in some embodiments, the transportation matching system 102 sends a transportation proposal notifying a user of a disruption event at a mass-transit station. The transportation proposal includes a selectable option to change a pickup location to an alternative pickup location suggested by the transportation matching system 102.

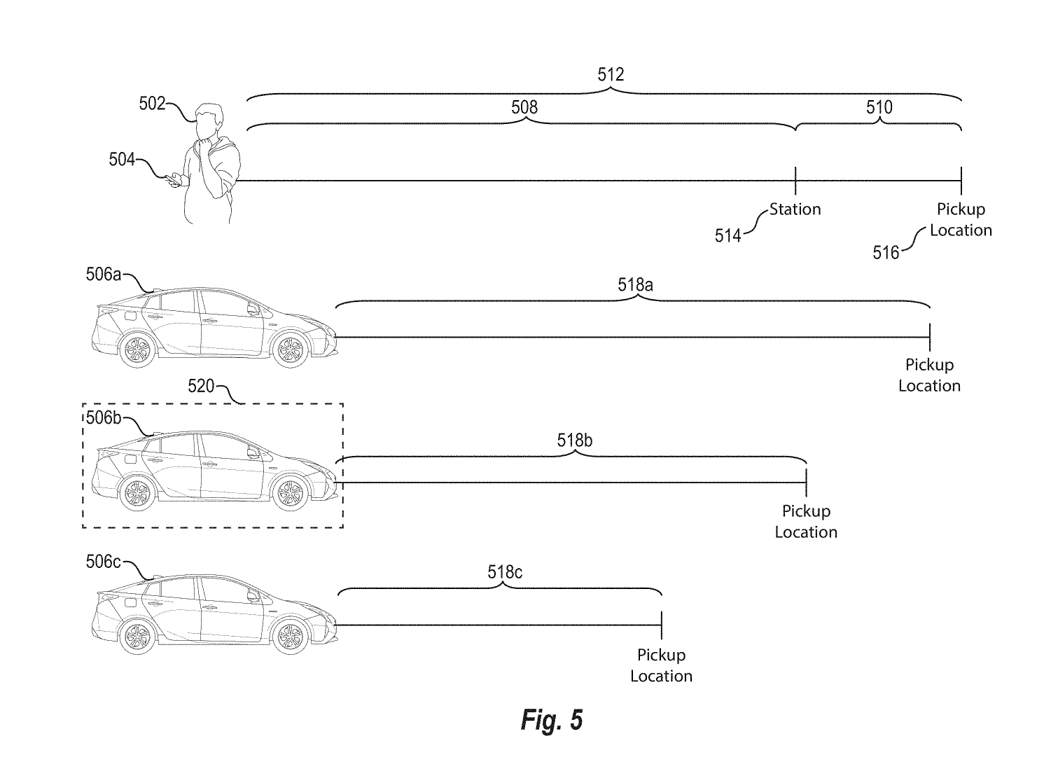

Turning now to FIG. 5, this figure illustrates a conceptual diagram of estimated transit times for a user and estimated transit times for transportation vehicles in accordance with one or more embodiments. Among other potential factors, the transportation matching system 102 selects a transportation matching system 102 to transport a user or a user group based on a comparison of estimated transit times of the user or user group and transportation vehicles. Although the following paragraphs describe estimated transit times of the user (or user group) and transportation vehicles, in some embodiments, the transportation matching system 102 compares a more specific time measurement, such as by comparing (1) estimated times of arrival of a user at a station and/or a pickup location and (ii) estimated times of arrival of transportation vehicles at the pickup location.

FIG. 5 depicts a user 502 and a user client device 504 associated with the user 502. The user 502 represents any of the users the transportation matching system 102 determines are traveling in a mass-transit vehicle. As part of selecting a transportation vehicle to receive a transportation-request notification, the transportation matching system 102 determines an estimated transit time of the user 502 from a location of a mass-transit vehicle to a mass-transit station 514. As shown in FIG. 5, the transportation matching system 102 determines an estimated transit time of the user 502 to a mass-transit station 514 based on sensory data from the user client device 504.

In particular, the transportation matching system 102 determines an estimated transit time of the user 502 from a location of the mass-transit vehicle to the mass-transit station 514 based on a location, direction, and speed of the mass-transit vehicle indicated by sensory data from the user client device 504. Consistent with the disclosure above, the user client device 504 sends location data from a GPS receiver and accelerometer data from an accelerometer to the transportation matching system 102 indicating a location, direction, and speed of the user client device 504. In some embodiments, the transportation matching system 102 determines additional estimated transit times based on additional user client devices within a same mass-transit vehicle as the user client device 504.

Additionally, the transportation matching system 102 determines an estimated transit time of the user 502 to the mass-transit station 514 based on scheduling information received from the mass-transit system 122. In certain embodiments, for instance, the transportation matching system 102 determines an estimated transit time of the user 502 to the mass-transit station 514 based on an estimated time of arrival of the mass-transit vehicle at the mass-transit station 514 from the scheduling information.

As discussed above, in one or more embodiments, the transportation matching system 102 estimates transit times utilizing a variety of different approaches and then combines (e.g., averages) the estimated transit times. For example, in relation to FIG. 5, the transportation matching system 102 averages the estimated transit time based on the user client device 504 (hereinafter, a “first estimated transit time”) and the estimated transit time based on the scheduling information (hereinafter a “second estimated transit time”). In some embodiments, for example, the transportation matching system 102 assigns a weight to the first estimated transit time and a different weight to the second estimated transit time. In some such embodiments, the transportation matching system 102 determines a sum of the weighted first estimated transit time and the weighted second estimated transit time to determine an average estimated transit time. In any event, the transportation matching system 102 uses the average estimated transit time to represent an estimated transit time 508 of the user 502 from a location of the mass-transit vehicle to the mass-transit station 514 shown in FIG. 5.

As further shown in FIG. 5, as part of selecting a transportation vehicle to receive a transportation-request notification, the transportation matching system 102 optionally determines an estimated transit time of the user 502 from the mass-transit station 514 to a pickup location 516. To be clear, in some embodiments, the transportation matching system 102 does not determine an estimated transit time of the user 502 from a mass-transit station to a pickup location. In some such embodiments, an estimated transit time of the user 502 from a mass-transit station to a pickup location may be negligible or insignificant based on a proximity of a pickup location to a mass-transit station.

As indicated in FIG. 5, however, the transportation matching system 102 determines an estimated transit time 510 of the user 502 from the mass-transit station 514 to the pickup location 516. In some such embodiments, the transportation matching system 102 determines the estimated transit time 510 based on a location of the user client device 504 within a mass-transit vehicle. The user client device 504's location within the mass-transit vehicle may correspond to a location within the mass-transit station 514 (e.g., a platform within a train station) and/or an expected exit time from a mass-transit vehicle (e.g., a seat in a front, middle, or back of an airplane).

In some embodiments, the transportation matching system 102 determines the estimated transit time 510 based on an average user traveling speed (e.g., 3.1 miles per hour for walking) and a location within the mass-transit station 514 (e.g., by multiplying the average user traveling speed by the distance from the location within the mass-transit station 514 to the pickup location). The transportation matching system 102 optionally uses a more specific average user traveling speed for a particular mass-transit station (e.g., 2.5 miler per hour for a busy mass-transit station). Similarly, in some embodiments, the transportation matching system 102 uses an average user traveling speed specific to a particular user to determine the estimated transit time 510. Additionally, in some embodiments, the transportation matching system 102 adds additional wait time to the estimated transit time 510 due to the user client device 504's location within the mass-transit vehicle (e.g., a wait time due to the user 502's location at a back of an airplane).

As further shown in FIG. 5, the transportation matching system 102 determines an aggregate estimated transit time 512 of the user 502 from a location of the mass-transit vehicle to the pickup location 516. As FIG. 5 indicates, the aggregate estimated transit time 512 equals a sum of the estimated transit time 508 and the estimated transit time 510. In embodiments where the transportation matching system 102 does not determine the estimated transit time 510, the aggregate estimated transit time 512 would equal the estimated transit time 508.

FIG. 5 further depicts a first transportation vehicle 506a, a second transportation vehicle 506b, and a third transportation vehicle 506c. Based on location data from provider client devices associated with the transportation vehicles 506a-506c, the transportation matching system 102 determines that the transportation vehicles 506a-506c are within a same geographic district or geographic neighborhood as the pickup location 516.

As used in this disclosure, the term “geographic district” refers to a spatial subdivision or unit of a larger geographic space. A geographic district may be a subdivision of a geographic neighborhood as well as a subdivision of a city. For example, a set of bordering streets may define a geographic district within a larger space, such as Chinatown of San Francisco, California or Tribeca of New York City, New York. In certain embodiments, a geographic district represents a geohash among other geohashes in a grid covering a larger geographic area. Relatedly, the term “geographic neighborhood” refers to a geographic region that includes multiple geographic districts.

As part of selecting a transportation vehicle to receive a transportation-request notification, the transportation matching system 102 determines an estimated transit time for each of the transportation vehicles 506a-508c to the pickup location 516. The transportation matching system 102 determines the estimated transit time for a transportation vehicle based in part on sensory data from provider client devices associated with each of the transportation vehicles 506a-508c, such as location data from a GPS receiver and accelerometer data from an accelerometer. To determine an estimated transit time for a transportation vehicle, the transportation matching system 102 optionally identifies a shortest route from a location of the transportation vehicle, a speed limit for each of the roads along the route, and multiplies the speed along each road by the distance of each road along the shortest route. Additionally, in some embodiments, the transportation matching system 102 detects traffic and decreases an expected speed of a transportation vehicle along a road based on the detected traffic. Alternatively, the transportation matching system 102 uses a commercially available routing service to determine an estimated transit time for a transportation vehicle to the pickup location 516.

As further shown in FIG. 5, the transportation matching system 102 determines an estimated transit time for each of the transportation vehicles from each transportation vehicle's respective location to the pickup location 516—with an estimated transit time 518a for the first transportation vehicle 506a, an estimated transit time 518b for the second transportation vehicle 506b, and an estimated transit time 518c for the third transportation vehicle 506c. The transportation matching system 102 then compares (i) the aggregate estimated transit time 512 with (ii) the estimated transit times 518a, 518b, and 518c.

To select a transportation vehicle to receive a transportation-request notification, the transportation matching system 102 optionally selects the transportation vehicle with an estimated transit time to the pickup location 516 similar to the aggregate estimate transit time 512. For example, in certain embodiments, the transportation matching system 102 selects the transportation vehicle with an estimated transit time to the pickup location 516 within a threshold differential time of the aggregate estimate transit time 512 (e.g., a two-minute threshold differential time). In some such embodiments, the transportation matching system 102 selects a transportation vehicle (i) within a geographic district or geographic neighborhood of the mass-transit station 514 and (ii) with an estimated transit time to the pickup location 516 within a threshold differential time of the aggregate estimate transit time 512. By selecting the transportation vehicle with an estimated transit time to the pickup location 516 within a threshold differential time, the transportation matching system 102 selects a transportation vehicle that will arrive at approximately within (or close to) the time at which the user 502 arrives at the pickup location 516.

The transportation matching system 102 can also select the transportation vehicle with the shortest estimated transit time to the pickup location 516. Furthermore, in some embodiments, the transportation matching system 102 selects the transportation vehicle with the shortest estimated transit time to the pickup location 516 within a threshold wait time to receive a transportation-request notification. The threshold wait time ensures that a provider of a transportation vehicle does not spend an excessive amount of time waiting for the user 502 to arrive at the pickup location 516. The threshold wait time may be, for example, two minutes. Accordingly, in some embodiments, the transportation matching system 102 excludes transportation vehicles that—if selected—would wait more than the threshold wait time.

In some embodiments, the transportation matching system 102 selects a transportation vehicle to receive a transportation-request notification after the aggregate estimated transit time 512 falls below a threshold estimated transit time. After the aggregate estimated transit time 512 falls below the threshold estimated transit time, such as ten or fifteen minutes, the transportation matching system 102 compares (i) the aggregate estimated transit time 512 with (ii) the estimated transit times 518a, 518b, and 518c and selects the transportation vehicle corresponding to the shortest estimated transit time to the pickup location 516.

In one or more embodiments, the transportation matching system 102 selects a transportation vehicle with an estimated transit time to the pickup location 516 that will result in the smallest amount of wait time for the provider or the user 502. For example, the transportation matching system 102 selects a transportation vehicle from among the transportation vehicles 506a-506c that results in a smallest total amount of wait time for the provider and the user 502. In some such embodiments, the transportation matching system 102 selects the transportation vehicle that results in the smallest amount of wait time for the provider to reduce idling and automobile emissions.

As indicated by a selection box 520 in FIG. 5, the transportation matching system 102 selects the second transportation vehicle 506b to receive a transportation-request notification for pickup of the user 502 at the pickup location 516. As indicated by FIG. 5, the second transportation vehicle 506b represents a transportation vehicle (i) within a geographic district or geographic neighborhood of the mass-transit station 514 and (ii) with an estimated transit time to the pickup location 516 similar to the aggregate estimate transit time 512 (e.g., within a threshold differential time). At the time of comparison in FIG. 5, the transportation vehicle 506a is located outside the geographic district or geographic neighborhood of the mass-transit station 514. Accordingly, the transportation matching system 102 sends the transportation-request notification to a provider client device associated with the second transportation vehicle 506b.

Turning now to FIGS. 6A-6B, these figures illustrate graphical user interfaces of a user client device 114a presenting selectable options for requesting transport from the transportation matching system 102 in accordance with one or more embodiments. Whereas FIG. 6A illustrates a push notification, FIG. 6B illustrates a transportation-request option—both of which may be selectable options for requesting transport.

As suggested above, all or a portion of the transportation matching system 102 can be implemented on the client device 114a (e.g., as part of the user application 116a), as computer-executable instructions that cause the user client device 114a to perform tasks depicted in FIGS. 2A-2B (such as presenting a selectable option for requesting transport). For ease of reference, this disclosure sometimes describes the user client device 114a as performing tasks, rather than the transportation matching system 102, as implemented by the client device 114a.

As shown in FIG. 6A, the user client device 114a presents a graphical user interface (“GUI”) 608 within a screen 602. The GUI 608 includes a calendar notification 604 and a push notification 606. As explained above, after determining that the user 118a is traveling within a mass-transit vehicle (and/or identifying a station for the user 118a), the transportation matching system 102 sends a push notification to the user client device 114a. The push notification 606 represents one such push notification.

As further shown in FIG. 6A, the push notification 606 suggests to the user 118a obtaining a transportation vehicle from a mass-transit station. In this particular embodiment, the push notification 606 asks, “Would you like Lyft to pick you up from San Francisco Station?” In some embodiments, the push notification 606 includes a selectable option that, when selected by the user 118a, causes the user client device 114a to present a graphical user interface of the user application 116a that includes a transportation-request option. In some embodiments, the user client device 114a opens the user application 116a in response to a user interaction with a thumbnail representing the user application 116a—before presenting a graphical user interface for the user application 116a that includes the transportation-request option.

Turning back now to FIG. 6B, this figure illustrates the user client device 114a presenting a transportation-request option 624 within an application graphical user interface (“GUI”) 610 of the screen 602. The user client device 114a further presents a set of tools that the user application 116a includes to facilitate sending arrival queries, price queries, and transportation requests. As shown, the application GUI 610 includes a transportation-type field 616, a pickup-location field 620, and a destination field 622. In response to the user 118a entering or selecting a transportation type within the transportation-type field 616, a pickup location within the pickup-location field 620, and a destination in the destination field 622, the user client device 114a sends an arrival query and a price query to the transportation matching system 102. In some embodiments, however, the transportation matching system 102 auto fills the pickup-location field 620 with an identified mass-transit station for the user 118a. As shown in FIG. 6B, the transportation matching system 102 has provided the user client device 114a with a specific mass-transit station as a reference point for a pickup location. The user client device 114a presents the specific mass-transit station within the pickup-location field 620.

Upon receiving the arrival query and the price query, the transportation matching system 102 generates a price estimate for transportation. The transportation matching system 102 also generates an estimated time of arrival for a transportation vehicle to pick up the user 118a at a pickup location. As indicated by FIG. 6B, the transportation matching system 102 sends the price estimate and the estimated time of arrival to the user client device 114a in response to the price query and the arrival query, respectively. Upon receiving data packets from the transportation matching system 102 that encode for the price estimate and the estimated time of arrival, the user client device 114a presents the price estimate within a price-estimate field 618 and the estimated time of arrival within an arrival-time indicator 614. In some embodiments, the transportation matching system 102 further sends a dropoff-time estimate to the user client device 114a, which the user client device 114a presents within a dropoff-time indicator 612.

Upon receiving the price estimate and the estimated time of arrival, the user client device 114a activates a transportation-request option 624. As its name suggests, in response to the user 118a selecting the transportation-request option 624 (e.g., by touch gesture or click), the user client device 114a sends a transportation request to the transportation matching system 102. In some embodiments, upon receiving the transportation request, the transportation matching system 102 sends a transportation-request notification to one or more of the provider client devices 110a-110n. Alternatively, in some embodiments, the transportation matching system 102 previously sent a transportation-request notification to one or more of the provider client devices 110a-110n in anticipation of a transportation request from the user 118a.

Although not shown in FIGS. 6A-6B, after sending a transportation request, the user client device 114a optionally receives a transportation confirmation from the transportation matching system 102. In some embodiments, the transportation confirmation indicates a pickup location corresponding to the mass-transit station in the pickup-location field 620. In some embodiments, the pickup location corresponding to the mass-transit station include a more specific identification than the mass-transit station as a reference point. For example, the transportation matching system 102 may identify the pickup location in a transportation confirmation as a landmark or recognizable location corresponding to the mass-transit station.

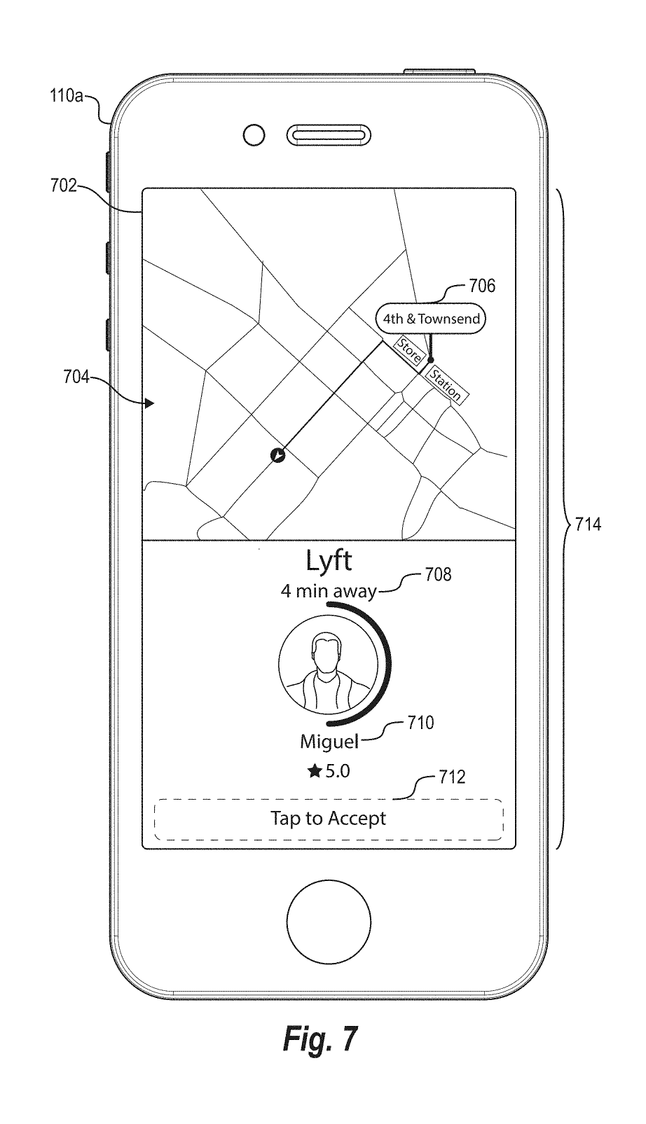

Turning now to FIG. 7, this figure illustrates an example of a transportation-request notification that the transportation matching system 102 sends to the provider client device 110a. As suggested above, the transportation matching system 102 (e.g., via the provider application 112a) causes the provider client device 110a to perform tasks depicted in FIGS. 2A-2B, such as presenting a transportation-request notification. FIG. 7 depicts the provider client device 110a presenting a transportation-request notification 714 within an application graphical user interface (“GUI”) 704 of a screen 702.

In general, the transportation-request notification notifies a provider of a transportation request from either a user or the server(s) 104. As shown in FIG. 7, the transportation-request notification 714 includes several indicators concerning the transportation request, including a pickup-location indicator 706, an arrival-time indicator 708, and a user indicator 710. The pickup-location indicator 706 indicates a pickup location corresponding to a mass-transit station. The arrival-time indicator 708 indicates an estimated time of arrival of a user at the pickup location. The user indicator 710 indicates an identity of the user for pickup.

As noted above, in some embodiments, a transportation-request notification includes (or is itself) a selectable option to accept a transportation request. As shown in FIG. 7, the transportation-request notification optionally includes an accept option 712. When the provider selects the accept option 712 (e.g., by touch gesture or click), the provider client device 110a sends an indication of the provider's selection accepting the transportation request to the transportation matching system 102. As described above, upon receiving the indication of the selection accepting the transportation request, the transportation matching system 102 optionally sends a transportation confirmation to a user client device associated with the requesting user.

In addition (or in the alternative) to determining a user is traveling in a mass-transit vehicle, in certain embodiments, the transportation matching system 102 determines a user is traveling in a transportation vehicle to a destination accessible to a mass-transit vehicle. For example, the transportation matching system 102 determines that a user is traveling in a transportation vehicle to a destination within a threshold distance of a mass-transit station. The transportation matching system 102 additionally determines that a mass-transit vehicle would transport the user to arrive at the destination (a) sooner than the transportation vehicle's estimated time of arrival at the destination and/or (b) at a lower cost to the user. In some embodiments, the transportation matching system 102 provides a suggestion to the user via a user client device to use a mass-transit vehicle from a mass-transit station to travel to the destination, instead of or in addition to the transportation vehicle. After receiving an indication from the user client device that the user selects to travel to the destination using the mass-transit vehicle, the transportation matching system 102 communicates with a mass-transit system to purchase (or arrange purchase of) a transportation pass for the user to the destination via the mass-transit vehicle.

In addition (or in the alternative) to arranging transportation to a destination via a mass-transit vehicle, in certain embodiments, the transportation matching system 102 facilitates payment for transportation using a mass-transit vehicle. For example, in certain embodiments, the transportation matching system 102 communicates with one or more mass-transit systems to purchase one or more transportation passes for mass-transit vehicles for a user. In some such embodiments, the transportation matching system 102 facilitates purchase of a transportation pass for a mass-transit vehicle using a user application of a user client device.

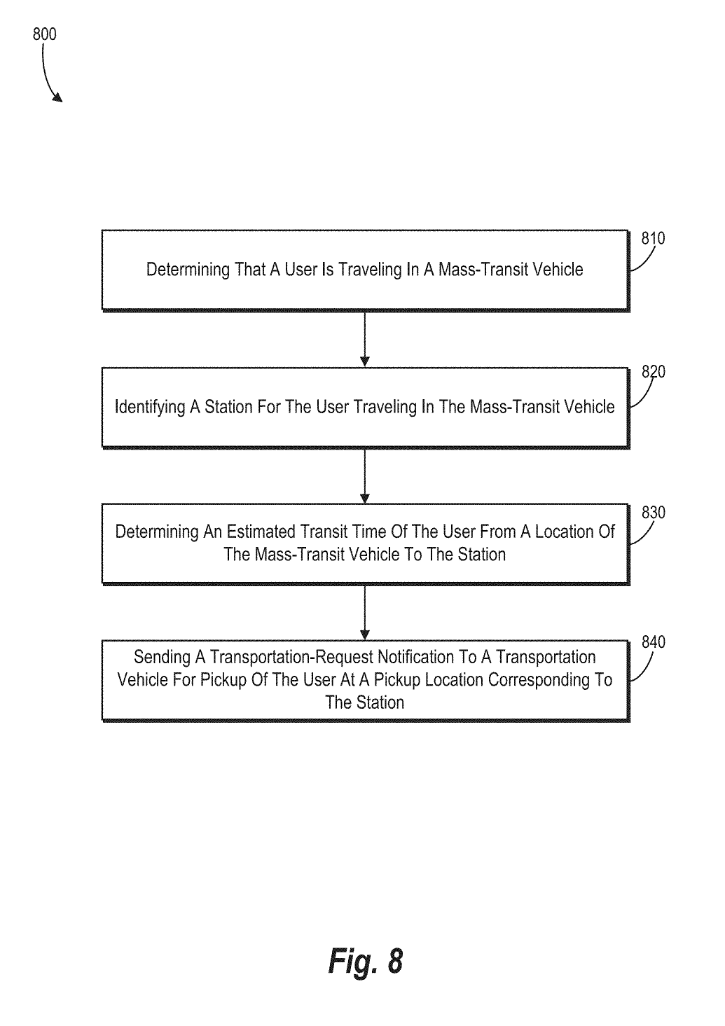

Turning now to FIG. 8, this figure illustrates a flowchart of a series of acts 800 of determining a user is traveling on a mass-transit vehicle and sending a transportation-request notification to a transportation vehicle for pickup of the user at a pickup location corresponding to a mass-transit station based on estimated transit times in accordance with one or more embodiments. While FIG. 8 illustrates acts according to one embodiment, alternative embodiments may omit, add to, reorder, and/or modify any of the acts shown in FIG. 8. The acts of FIG. 8 can be performed as part of a method. Alternatively, a non-transitory computer readable storage medium can comprise instructions that, when executed by one or more processors, cause a computing device to perform the acts depicted in FIG. 8. In still further embodiments, a system can perform the acts of FIG. 8.

As shown in FIG. 8, the acts 800 include an act 810 of determining that a user is traveling in a mass-transit vehicle. For example, in certain implementations, determining that the user is traveling in the mass-transit vehicle comprises determining that the user is traveling in the mass-transit vehicle based on sensory data from one or more of an accelerometer, altimeter, barometer, Global Positioning System receiver, gyroscope, or magnetometer of the client device.

As further shown in FIG. 8, the acts 800 include an act 820 of identifying a station for the user traveling in the mass-transit vehicle and an act 830 of determining an estimated transit time of the user from a location of the mass-transit vehicle to the station. In particular, in some embodiments, the act 830 includes, based on determining that the user is traveling in the mass-transit vehicle, determining an estimated transit time of the user from a location of the mass-transit vehicle to the station.

As noted above, in certain embodiments, identifying the station for the user traveling in the mass-transit vehicle comprises determining a probability that the user will utilize the transportation vehicle; and based on the probability that the user will utilize the transportation vehicle, sending a transportation-request notification to a transportation vehicle for pickup of the user at a pickup location corresponding to the station.

By contrast, in certain embodiments, identifying the station for the user traveling in the mass-transit vehicle comprises providing, to the client device, a selectable option for requesting transport; and based on user interaction with the selectable option, receiving, from the client device, an indication of a transportation request by the user for a transportation vehicle.

As suggested above, in certain embodiments, determining the estimated transit time of the user from the location of the mass-transit vehicle to the station comprises determining the estimated transit time of the user from the location of the mass-transit vehicle to the station based on one or more of: the sensory data from the client device; additional sensory data from additional client devices associated with additional users on the mass-transit vehicle; or scheduling information from a mass-transit system.

As also shown in FIG. 8, the acts 800 include an act 840 of sending a transportation-request notification to a transportation vehicle for pickup of the user at a pickup location corresponding to the station. For example, in certain embodiments, the transportation-request notification comprises an acceptance option for a provider to accept a transportation request by the user for the transportation vehicle from a transportation matching system.

In addition to the acts 810-840, in some embodiments, the acts 800 further include determining an additional estimated transit time of the user from the station to the pickup location; and sending the transportation-request notification to the transportation vehicle for pickup of the user at the pickup location based further on the additional estimated transit time of the user from the station to the pickup location. For instance, in certain embodiments, determining the additional estimated transit time of the user from the station to the pickup location comprises determining the additional estimated transit time of the user from the station to the pickup location based on an average user traveling speed in the station. Moreover, in certain embodiments, the acts 800 further include identifying the station for the user traveling in the mass-transit vehicle by determining that a travel history for the user indicates that the user previously utilized mass-transit vehicles at the station.

As suggested above, in some embodiments, the acts 800 further include determining a further estimated transit time for each of multiple transportation vehicles to the pickup location; comparing an aggregate estimated transit time of the user from the location of the mass-transit vehicle to the pickup location with the further estimated transit time for each of the multiple transportation vehicles; selecting the transportation vehicle from the multiple transportation vehicles based on comparing the aggregate estimated transit time with the further estimated transit time for each of the multiple transportation vehicles; and sending the transportation-request notification to the transportation vehicle for pickup of the user at the pickup location based further on selecting the transportation vehicle from the multiple transportation vehicles.

As noted above, in certain embodiments, the transportation matching system 102 services a plurality of user traveling on a mass-transit vehicle. For example, in one or more embodiments, the acts 800 further include determining that additional users are traveling in the mass-transit vehicle based on sensory data from client devices associated with the additional users; determining one or more transit characteristics of the user and the additional users; and creating one or more user groups based on the one or more transit characteristics of the user and the additional users; and wherein sending the transportation-request notification to the transportation vehicle for pickup of the user at the pickup location comprises sending the transportation-request notification to the transportation vehicle to pick up one user group of the one or more user groups at the pickup location.

Relatedly, in some embodiments, the acts 800 further include determining the one or more transit characteristics of the user and the additional users comprises determining one or more of: a location of each of the user and the additional users within the mass-transit vehicle; a traveling speed of each of the user and the additional users; an additional estimated transit time from the station to the pickup location for each of the user and the additional users; or a destination indicated by a transportation request from each of the client device associated with the user and the client devices associated with the additional users. Additionally, in certain embodiments, the acts 800 further include reorganizing the one or more user groups based on one or more updated transit characteristics of the user and the additional users.

As also noted above, the transportation matching system 102 arranges for different transportation vehicles to transport different user groups. For example, in some embodiments, the acts 800 further include sending an additional transportation-request notification to an additional transportation vehicle for pickup of an additional user group of the one or more user groups. Relatedly, in certain implementations, sending the additional transportation-request notification to the additional transportation vehicle for pickup of the additional user group comprises sending the additional transportation-request notification to the additional transportation vehicle for pickup of the additional user group at an additional pickup location based on the one or more transit characteristics of the user and the additional users.

Additionally, in certain embodiments, the acts 800 further include determining the pickup location based on one or more of a location of the client device within the mass-transit vehicle or a disruption event. Moreover, in some embodiments, the acts 800 further include determining the pickup location based on the disruption event by determining the pickup location based on one or more of: a publicly scheduled event near the station; a vehicular accident near the station; vehicular traffic near the station; or a weather event near the station. Moreover, in some embodiments, the acts 800 further include determine that exiting from an alternative station would result in an improved estimated transit time to a destination; and providing, to the client device, a suggestion to use the alternative station.

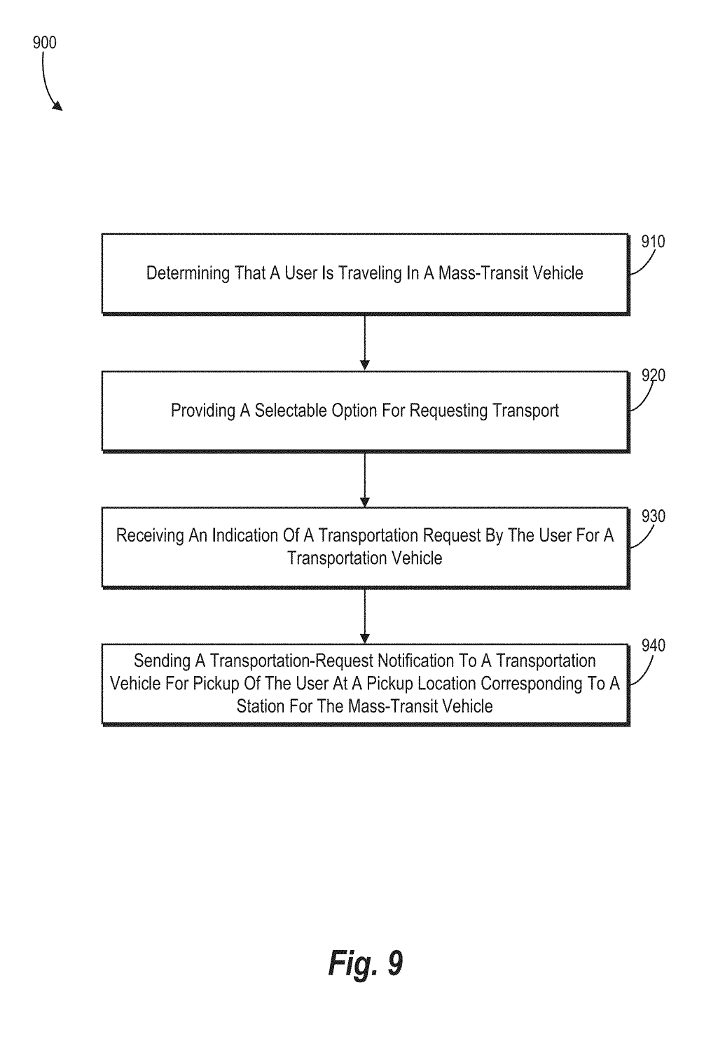

Turning now to FIG. 9, this figure illustrates a flowchart of a series of acts 900 of determining a user is traveling on a mass-transit vehicle and sending a transportation-request notification to a transportation vehicle for pickup of a user at a pickup location corresponding to a mass-transit station based on user interaction with a selectable option in accordance with one or more embodiments. While FIG. 9 illustrates acts according to one embodiment, alternative embodiments may omit, add to, reorder, and/or modify any of the acts shown in FIG. 9. The acts of FIG. 9 can be performed as part of a method. Alternatively, a non-transitory computer readable storage medium can comprise instructions that, when executed by one or more processors, cause a computing device to perform the acts depicted in FIG. 9. In still further embodiments, a system can perform the acts of FIG. 9.

As shown in FIG. 9, the acts 900 include an act 910 of determining that a user is traveling in a mass-transit vehicle. For example, determining that the user is traveling in the mass-transit vehicle comprises determining that the user is traveling in the mass-transit vehicle based on sensory data from one or more of an accelerometer, altimeter, barometer, Global Positioning System receiver, gyroscope, or magnetometer of the client device.

As further shown in FIG. 9, the acts 900 include an act 920 of providing a selectable option for requesting transport from a transportation matching system. In particular, the act 920 includes, based on determining that the user is traveling in the mass-transit vehicle, providing, to the client device, a selectable option for requesting transport. For example, in certain embodiments, providing the selectable option for requesting transport comprises receiving an indication that the client device opens a transportation software application; and providing the selectable option for requesting transport based on receiving the indication that the client device opens the transportation software application.

Moreover, in certain embodiments, providing the selectable option for requesting transport comprises determining that a travel history for the user indicates that the user previously utilized mass-transit vehicles at the station; and providing the selectable option for requesting transport further based on determining the travel history for the user.

As also shown in FIG. 9, the acts 900 include an act 930 of receiving an indication of a transportation request by the user for a transportation vehicle from the transportation matching system and an act 940 of sending a transportation-request notification to a transportation vehicle for pickup of the user at a pickup location corresponding to a station of the mass-transit vehicle. For example, in certain embodiments, the transportation-request notification comprises an acceptance option for a provider to accept the transportation request by the user for the transportation vehicle from the transportation matching system.

In addition to the acts 910-940, in certain embodiments, the acts 900 further include determining the pickup location based on one or more of a location of the client device within the mass-transit vehicle or a disruption event. Moreover, in some embodiments, the acts 900 further include determining the pickup location based on the disruption event by determining the pickup location based on one or more of: a publicly scheduled event near the station; a vehicular accident near the station; vehicular traffic near the station; or a weather event near the station.

As suggested above, in some embodiments, the acts 900 further include identifying a disruption event near the station; and providing, to the client device, an additional selectable option to change the pickup location to an alternative pickup location. In certain implementations, the additional selectable option to change the pickup location to the alternative pickup location comprises an option to change the pickup location to an alternative station. Similarly, in certain embodiments, the additional selectable option to change the pickup location to the alternative pickup location comprises an option to change the pickup location to the alternative pickup location corresponding to an alternative station.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 10 illustrates, in block diagram form, an exemplary computing device 1000 that may be configured to perform one or more of the processes described above. One will appreciate that the transportation matching system 102 can comprise implementations of the computing device 1000, including, but not limited to, the server(s) 104, the provider client devices 110a-110n, the user client devices 114a-114n, the user client devices 408a-408e, and the user client device 504. As shown by FIG. 10, the computing device can comprise a processor 1002, memory 1004, a storage device 1006, an I/O interface 1008, and a communication interface 1010. In certain embodiments, the computing device 1000 can include fewer or more components than those shown in FIG. 10. Components of computing device 1000 shown in FIG. 10 will now be described in additional detail.

In particular embodiments, processor(s) 1002 includes hardware for executing instructions, such as those making up a computer program. As an example, and not by way of limitation, to execute instructions, processor(s) 1002 may retrieve (or fetch) the instructions from an internal register, an internal cache, memory 1004, or a storage device 1006 and decode and execute them.

The computing device 1000 includes memory 1004, which is coupled to the processor(s) 1002. The memory 1004 may be used for storing data, metadata, and programs for execution by the processor(s). The memory 1004 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 1004 may be internal or distributed memory.

The computing device 1000 includes a storage device 1006 includes storage for storing data or instructions. As an example, and not by way of limitation, storage device 1006 can comprise a non-transitory storage medium described above. The storage device 1006 may include a hard disk drive (“HDD”), flash memory, a Universal Serial Bus (“USB”) drive or a combination of these or other storage devices.

The computing device 1000 also includes one or more input or output (“I/O”) interface 1008, which are provided to allow a user (e.g., requestor or provider) to provide input to (such as user strokes), receive output from, and otherwise transfer data to and from the computing device 1000. These I/O interface 1008 may include a mouse, keypad or a keyboard, a touch screen, camera, optical scanner, network interface, modem, other known I/O devices or a combination of such I/O interface 1008. The touch screen may be activated with a stylus or a finger.

The I/O interface 1008 may include one or more devices for presenting output to a user, including, but not limited to, a graphics engine, a display (e.g., a display screen), one or more output providers (e.g., display providers), one or more audio speakers, and one or more audio providers. In certain embodiments, the I/O interface 1008 is configured to provide graphical data to a display for presentation to a user. The graphical data may be representative of one or more graphical user interfaces and/or any other graphical content as may serve a particular implementation.

The computing device 1000 can further include a communication interface 1010. The communication interface 1010 can include hardware, software, or both. The communication interface 1010 can provide one or more interfaces for communication (such as, for example, packet-based communication) between the computing device and one or more other computing devices 1000 or one or more networks. As an example, and not by way of limitation, communication interface 1010 may include a network interface controller (“NIC”) or network adapter for communicating with an Ethernet or other wire-based network or a wireless NIC (“WNIC”) or wireless adapter for communicating with a wireless network, such as a WI-FI. The computing device 1000 can further include a bus 1012. The bus 1012 can comprise hardware, software, or both that couples components of computing device 1000 to each other.

FIG. 11 illustrates an example network environment 1100 of a dynamic transportation matching system. The network environment 1100 includes a client device 1106, a transportation matching system 1102, and a vehicle subsystem 1108 connected to each other by a network 1104. Although FIG. 11 illustrates a particular arrangement of the client device 1106, transportation matching system 1102, vehicle subsystem 1108, and network 1104, this disclosure contemplates any suitable arrangement of client device 1106, transportation matching system 1102, vehicle subsystem 1108, and network 1104. As an example, and not by way of limitation, two or more of client device 1106, transportation matching system 1102, and vehicle subsystem 1108 communicate directly, bypassing network 1104. As another example, two or more of client device 1106, transportation matching system 1102, and vehicle subsystem 1108 may be physically or logically co-located with each other in whole or in part. Moreover, although FIG. 11 illustrates a particular number of client devices 1106, transportation matching systems 1102, vehicle subsystems 1108, and networks 1104, this disclosure contemplates any suitable number of client devices 1106, transportation matching systems 1102, vehicle subsystems 1108, and networks 1104. As an example, and not by way of limitation, network environment 1100 may include multiple client device 1106, transportation matching systems 1102, vehicle subsystems 1108, and networks 1104.

This disclosure contemplates any suitable network 1104. As an example, and not by way of limitation, one or more portions of network 1104 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 1104 may include one or more networks 1104.

Links may connect client device 1106, transportation matching system 1102, and vehicle subsystem 1108 to network 1104 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links.

In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 1100. One or more first links may differ in one or more respects from one or more second links.

In particular embodiments, client device 1106 may be an electronic device including hardware, software, or embedded logic components or a combination of two or more such components and capable of carrying out the appropriate functionalities implemented or supported by client device 1106. As an example, and not by way of limitation, a client device 1106 may include any of the computing devices discussed above in relation to FIG. 10. A client device 1106 may enable a network user at client device 1106 to access network 1104. A client device 1106 may enable its user to communicate with other users at other client devices 1106.

In particular embodiments, client device 1106 may include a requestor application or a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client device 1106 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to client device 1106 one or more Hyper Text Markup Language (“HTML”) files responsive to the HTTP request. Client device 1106 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, transportation matching system 1102 may be a network-addressable computing system that can host a transportation matching network. Transportation matching system 1102 may generate, store, receive, and send data, such as, for example, user-profile data, concept-profile data, text data, transportation request data, GPS location data, provider data, requestor data, vehicle data, or other suitable data related to the transportation matching network. This may include authenticating the identity of providers and/or vehicles who are authorized to provide transportation services through the transportation matching system 1102. In addition, the dynamic transportation matching system may manage identities of service requestors such as users/requestors. In particular, the dynamic transportation matching system may maintain requestor data such as driving/riding histories, personal data, or other user data in addition to navigation and/or traffic management services or other location services (e.g., GPS services).

In particular embodiments, the transportation matching system 1102 may manage transportation matching services to connect a user/requestor with a vehicle and/or provider. By managing the transportation matching services, the transportation matching system 1102 can manage the distribution and allocation of resources from the vehicle subsystems 108a and 108n and user resources such as GPS location and availability indicators, as described herein.

Transportation matching system 1102 may be accessed by the other components of network environment 1100 either directly or via network 1104. In particular embodiments, transportation matching system 1102 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by server. In particular embodiments, transportation matching system 1102 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 1106, or a transportation matching system 1102 to manage, retrieve, modify, add, or delete, the information stored in data store.

In particular embodiments, transportation matching system 1102 may provide users with the ability to take actions on various types of items or objects, supported by transportation matching system 1102. As an example, and not by way of limitation, the items and objects may include transportation matching networks to which users of transportation matching system 1102 may belong, vehicles that users may request, location designators, computer-based applications that a user may use, transactions that allow users to buy or sell items via the service, interactions with advertisements that a user may perform, or other suitable items or objects. A user may interact with anything that is capable of being represented in transportation matching system 1102 or by an external system of a third-party system, which is separate from transportation matching system 1102 and coupled to transportation matching system 1102 via a network 1104.

In particular embodiments, transportation matching system 1102 may be capable of linking a variety of entities. As an example, and not by way of limitation, transportation matching system 1102 may enable users to interact with each other or other entities, or to allow users to interact with these entities through an application programming interfaces (“API”) or other communication channels.

In particular embodiments, transportation matching system 1102 may include a variety of servers, sub-systems, programs, modules, logs, and data stores. In particular embodiments, transportation matching system 1102 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Transportation matching system 1102 may also include suitable components such as network interfaces, security mechanisms, load balancers, failover servers, management-and-network-operations consoles, other suitable components, or any suitable combination thereof. In particular embodiments, transportation matching system 1102 may include one or more user-profile stores for storing user profiles. A user profile may include, for example, biographic information, demographic information, behavioral information, social information, or other types of descriptive information, such as work experience, educational history, hobbies or preferences, interests, affinities, or location.

The web server may include a mail server or other messaging functionality for receiving and routing messages between transportation matching system 1102 and one or more client devices 1106. An action logger may be used to receive communications from a web server about a user's actions on or off transportation matching system 1102. In conjunction with the action log, a third-party-content-object log may be maintained of user exposures to third-party-content objects. A notification controller may provide information regarding content objects to a client device 1106. Information may be pushed to a client device 1106 as notifications, or information may be pulled from client device 1106 responsive to a request received from client device 1106. Authorization servers may be used to enforce one or more privacy settings of the users of transportation matching system 1102. A privacy setting of a user determines how particular information associated with a user can be shared. The authorization server may allow users to opt in to or opt out of having their actions logged by transportation matching system 1102 or shared with other systems, such as, for example, by setting appropriate privacy settings. Third-party-content-object stores may be used to store content objects received from third parties. Location stores may be used for storing location information received from client devices 1106 associated with users.

In addition, the vehicle subsystem 1108 can include a human-operated vehicle or an autonomous vehicle. A provider of a human-operated vehicle can perform maneuvers to pick up, transport, and drop off one or more requestors according to the embodiments described herein. In certain embodiments, the vehicle subsystem 1108 can include an autonomous vehicle—i.e., a vehicle that does not require a human operator. When a transportation vehicle is an autonomous vehicle, the transportation vehicle may include additional components not depicted in FIG. 1 or FIG. 11, such as location components, one or more sensors by which the autonomous vehicle navigates, and/or other components necessary to navigate without a provider (or with minimal interactions with a provider). In these embodiments, the vehicle subsystem 1108 can perform maneuvers, communicate, and otherwise function without the aid of a human provider, in accordance with available technology.

Additionally, in some embodiments, the vehicle subsystem 1108 includes a hybrid self-driving vehicle with both self-driving functionality and some human operator interaction. This human operator interaction may work in concert with or independent of the self-driving functionality. In other embodiments, the vehicle subsystems 1108 includes an autonomous provider that acts as part of the transportation vehicle, such as a computer-based navigation and driving system that acts as part of a transportation vehicle. Regardless of whether a transportation vehicle is associated with a provider, a transportation vehicle optionally includes a locator device, such as a GPS device, that determines the location of the transportation vehicle within the vehicle subsystem 1108.

In particular embodiments, the vehicle subsystem 1108 may include one or more sensors incorporated therein or associated thereto. For example, sensor(s) 1110 can be mounted on the top of the vehicle subsystem 1108 or else can be located within the interior of the vehicle subsystem 1108. In certain embodiments, the sensor(s) 1110 can be located in multiple areas at once—i.e., split up throughout the vehicle subsystem 1108 so that different components of the sensor(s) 1110 can be placed in different locations in accordance with optimal operation of the sensor(s) 1110. In these embodiments, the sensor(s) 1110 can include a LIDAR sensor and an inertial measurement unit (“IMU”) including one or more accelerometers, one or more gyroscopes, and one or more magnetometers. The sensor(s) 1110 can additionally or alternatively include a wireless IMU (“WIMU”), one or more cameras, one or more microphones, or other sensors or data input devices capable of receiving and/or recording information relating to navigating a route to pick up, transport, and/or drop off a requestor.

In particular embodiments, the vehicle subsystem 1108 may include a communication device capable of communicating with the client device 1106 and/or the transportation matching system 1102. For example, the vehicle subsystem 1108 can include an on-board computing device communicatively linked to the network 1104 to transmit and receive data such as GPS location information, sensor-related information, requestor location information, or other relevant information.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

We claim:

1. A system comprising:
at least one processor; and
at least one non-transitory computer readable storage medium storing instructions that, when executed by the at least one processor, cause the system to:
determine that a user is traveling in a mass-transit vehicle based on sensory data from a client device associated with the user;
identify a station for the user traveling in the mass-transit vehicle;
based on determining that the user is traveling in the mass-transit vehicle, determine an estimated transit time of the user from a location of the mass-transit vehicle to the station; and
based on determining the estimated transit time of the user from the location of the mass-transit vehicle to the station, send a transportation-request notification to a transportation vehicle for pickup of the user at a pickup location corresponding to the station.

2. The system of claim 1, further comprising instructions that, when executed by the at least one processor, cause the system to determine that the user is traveling in the mass-transit vehicle based on sensory data from one or more of an accelerometer, altimeter, barometer, Global Positioning System receiver, gyroscope, or magnetometer of the client device.

3. The system of claim 1, further comprising instructions that, when executed by the at least one processor, cause the system to:
determine a probability that the user will utilize the transportation vehicle; and
based on the probability that the user will utilize the transportation vehicle, send the transportation-request notification to the transportation vehicle for pickup of the user at the pickup location corresponding to the station.

4. The system of claim 1, further comprising instructions that, when executed by the at least one processor, cause the system to determine the estimated transit time of the user from the location of the mass-transit vehicle to the station based on one or more of:
the sensory data from the client device;
additional sensory data from additional client devices associated with additional users on the mass-transit vehicle; or
scheduling information from a mass-transit system.

5. The system of claim 1, further comprising instructions that, when executed by the at least one processor, cause the system to identify the station for the user traveling in the mass-transit vehicle by determining that a travel history for the user indicates that the user previously utilized one or more mass-transit vehicles at the station.

6. The system of claim 1, further comprising instructions that, when executed by the at least one processor, cause the system to:
determine a further estimated transit time for each of multiple transportation vehicles to the pickup location;
compare an aggregate estimated transit time of the user from the location of the mass-transit vehicle to the pickup location with the further estimated transit time for each of the multiple transportation vehicles;
select the transportation vehicle from the multiple transportation vehicles based on comparing the aggregate estimated transit time with the further estimated transit time for each of the multiple transportation vehicles; and
send the transportation-request notification to the transportation vehicle for pickup of the user at the pickup location based further on selecting the transportation vehicle from the multiple transportation vehicles.

7. The system of claim 1, further comprising instructions that, when executed by the at least one processor, cause the system to determine the pickup location based on one or more of a location of the client device within the mass-transit vehicle or a disruption event.

8. The system of claim 7, further comprising instructions that, when executed by the at least one processor, cause the system to determine the pickup location based on the disruption event by determining the pickup location based on one or more of:
a publicly scheduled event near the station;
a vehicular accident near the station;
vehicular traffic near the station; or
a weather event near the station.

9. The system of claim 1, further comprising instructions that, when executed by the at least one processor, cause the system to:
determine that additional users are traveling in the mass-transit vehicle based on sensory data from client devices associated with the additional users;
determine one or more transit characteristics of the user and the additional users; and
create one or more user groups based on the one or more transit characteristics of the user and the additional users; and
send the transportation-request notification to the transportation vehicle to pick up one user group of the one or more user groups at the pickup location.

10. The system of claim 9, further comprising instructions that, when executed by the at least one processor, cause the system to determine the one or more transit characteristics of the user and the additional users by determining one or more of:
a location of each of the user and the additional users within the mass-transit vehicle;
a traveling speed of each of the user and the additional users;
an additional estimated transit time from the station to the pickup location for each of the user and the additional users; or
a destination indicated by a transportation request from each of the client device associated with the user and the client devices associated with the additional users.

11. A non-transitory computer readable medium storing instructions thereon that, when executed by at least one processor, cause a system to:
determine that a user is traveling in a mass-transit vehicle based on sensory data from a client device associated with the user;
identify a station for the user traveling in the mass-transit vehicle;
based on determining that the user is traveling in the mass-transit vehicle, determine an estimated transit time of the user from a location of the mass-transit vehicle to the station; and
based on determining the estimated transit time of the user from the location of the mass-transit vehicle to the station, send a transportation-request notification to a transportation vehicle for pickup of the user at a pickup location corresponding to the station for the mass-transit vehicle.

12. The non-transitory computer readable medium of claim 11, further comprising instructions that, when executed by the at least one processor, cause the system to identify the station for the user traveling in the mass-transit vehicle by:
providing, to the client device, a selectable option for requesting transport; and
based on user interaction with the selectable option, receiving, from the client device, an indication of a transportation request by the user for a transportation vehicle.

13. The non-transitory computer readable medium of claim 11, further comprising instructions that, when executed by the at least one processor, cause the system to:
determine that exiting from an alternative station would result in an improved estimated transit time to a destination; and
provide, to the client device, a suggestion to use the alternative station.

14. The non-transitory computer readable medium of claim 11, further comprising instructions that, when executed by the at least one processor, cause the system to identify the station for the user traveling in the mass-transit vehicle by determining that a travel history for the user indicates that the user previously utilized one or more mass-transit vehicles at the station.

15. The non-transitory computer readable medium of claim 11, further comprising instructions that, when executed by the at least one processor, cause the system to:
determine that additional users are traveling in the mass-transit vehicle based on sensory data from client devices associated with the additional users;
determine one or more transit characteristics of the user and the additional users; and
create one or more user groups based on the one or more transit characteristics of the user and the additional users; and
send the transportation-request notification to the transportation vehicle to pick up one user group of the one or more user groups at the pickup location.

16. A method comprising:
determining that a user is traveling in a mass-transit vehicle based on sensory data from a client device associated with the user;
identifying a station for the user traveling in the mass-transit vehicle;
based on determining that the user is traveling in the mass-transit vehicle, determining an estimated transit time of the user from a location of the mass-transit vehicle to the station; and
based on determining the estimated transit time of the user from the location of the mass-transit vehicle to the station, sending a transportation-request notification to a transportation vehicle for pickup of the user at a pickup location corresponding to the station.

17. The method of claim 16, further comprising:
determining a probability that the user will utilize the transportation vehicle; and
based on the probability that the user will utilize the transportation vehicle, sending the transportation-request notification to the transportation vehicle for pickup of the user at the pickup location corresponding to the station.

18. The method of claim 16, wherein determining the estimated transit time of the user from the location of the mass-transit vehicle to the station is based on one or more of:
the sensory data from the client device;
additional sensory data from additional client devices associated with additional users on the mass-transit vehicle; or
scheduling information from a mass-transit system.

19. The method of claim 16, wherein identifying the station for the user traveling in the mass-transit vehicle comprises determining that a travel history for the user indicates that the user previously utilized one or more mass-transit vehicles at the station.

20. The method of claim 16, further comprising:
determining that additional users are traveling in the mass-transit vehicle based on sensory data from client devices associated with the additional users;
determining one or more transit characteristics of the user and the additional users; and
creating one or more user groups based on the one or more transit characteristics of the user and the additional users; and
wherein sending the transportation-request notification to the transportation vehicle for pickup of the user at the pickup location comprises sending the transportation-request notification to the transportation vehicle to pick up one user group of the one or more user groups at the pickup location.
